(19) United States
(12) Patent Application Publication
(10) Pub. No.: US 2023/0052121 A1
(43) Pub. Date: Feb. 16, 2023

(54) MEMORY DEVICE THAT IS OPTIMIZED FOR LOW POWER OPERATION

(71) Applicant: SanDisk Technologies LLC, Addison, TX (US)

(72) Inventors: Xiang Yang, Santa Clara, CA (US); Masaaki Higanshitani, San Jose, CA (US)

(73) Assignee: SanDisk Technologies LLC, Addison, TX (US)

(21) Appl. No.: 17/402,989

(22) Filed: Aug. 16, 2021

(51) Int. Cl. G11C 16/10; G11C 16/04; G11C 16/08; G11C 16/34; G11C 16/26; G06F 16/2458; H04L 9/12

(52) U.S. Cl. CPC G11C 16/10; G11C 16/0483; G11C 16/08; G11C 16/3459; G11C 16/349; G11C 16/26; G06F 16/2465; H04L 9/12; H01L 27/11556

(57) ABSTRACT

A storage device that includes a non-volatile memory is provided. The non-volatile memory includes a control circuitry that is communicatively coupled to a memory block that includes memory cells arranged word lines. The control circuitry is configured to program the memory cells of a selected word line in a plurality of programming loops to store a single bit of data in each memory cell of the selected word line. The programming loops include programming operations and verify operations. The programming operations include applying a programming voltage to the selected word line, and the verify operations include applying a verify voltage to the selected word line. At least one programming loop of the plurality of programming loops further includes a pre-verify operation. The pre-verify operation includes applying a pre-read voltage to the selected word line. The pre-read voltage is less than the verify voltage.

### BACKGROUND

### 1. Field

The present technology relates to the operation of memory devices and, more particularly, to memory devices that are optimized for use in the mining of certain types of cryptocurrencies.

### 2. Related Art

Some modern types of cryptocurrencies rely on storage, rather than computational power, in mining. In some examples, mining these cryptocurrencies involves storing so-called “plots,” which can be approximately 100 GB in size, into a memory device, such as a solid state drive (SSD) or a hard disk drive (HDD). The mining operation may involve a large number of program/erase cycles to program and erase plots. In one mining technique, a high speed SSD, such as of the type having a flash NAND array architecture, may be utilized for temporary storage for one or more plots until those plots are copied to a relatively slower HDD for long term storage.

Such SSDs may be provided as internal, semiconductor, integrated circuits in computers or other electronic devices. In a flash NAND array architecture, memory cells may be arranged in a matrix of rows and columns such that gates of each memory cell are coupled by rows to word lines. The memory cells may also be arranged together in strings such that memory cells in a given string are coupled together in series, from source to drain, between a common source line and a common bit line.

### SUMMARY

An aspect of the present disclosure is related to a method of operating a memory device. The method includes the step of preparing a memory device that includes a plurality of memory cells arranged in a plurality of word lines. The method further includes the step of programming the memory cells of a selected word line of the plurality of word lines in a plurality of programming loops to store a single bit of data in each memory cell of the selected word line. The programming loops include programming operations during which a programming voltage is applied to the selected word line. The programming loops also include verify operations during which a verify voltage is applied to the selected word line. At least one of the programming loops of the plurality of programming loops further includes a pre-verify operation. The pre-verify operation includes applying a pre-read voltage to the selected word line. The pre-read voltage is less than the verify voltage.

According to an aspect of the present disclosure, only a first programming loop of the plurality of programming loops includes the pre-verify operation.

According to another aspect of the present disclosure, in the first programming loop of the plurality of programming loops, the pre-verify operation identifies a set of low threshold voltage memory cells that have threshold voltages that are less than the pre-read voltage. Only the set of low threshold voltage memory cells are programmed during the programming operation of the first programming loop.

According to yet another aspect of the present disclosure, at least a first programming loop and a second programming loop of the plurality of programming loops include pre-verify operations.

According to still another aspect of the present disclosure, the pre-read voltage applied to the selected word line during the pre-verify operation of the first programming loop is a first pre-read voltage and the pre-read voltage applied to the selected word line during the pre-verify operation of the second programming loop is a second pre-read voltage. The second pre-read voltage is greater than the first pre-read voltage.

According to a further aspect of the present disclosure, during at least the first programming loop and the second programming loop, the pre-verify operation identifies a set of low threshold voltage memory cells that have threshold voltages that are less than the pre-read voltage. During the verify operation of at least the first programming loop, the set of low threshold voltage memory cells are locked out.

According to yet a further aspect of the present disclosure, the pre-read voltage is determined as a function of the verify voltage.

According to still a further aspect of the present disclosure, the method further includes the steps of tracking lifetime program-erase cycles in the memory device and increasing the verify voltage with increasing program-erase cycles.

According to another aspect of the present disclosure, the memory device only has a single power input that is no greater than 1.5 V.

Another aspect of the present disclosure is related to a storage device that includes a non-volatile memory. The non-volatile memory includes a control circuitry that is communicatively coupled to a memory block that includes a plurality of memory cells arranged in a plurality of word lines. The control circuitry is configured to program the memory cells of a selected word line of the plurality of word lines in a plurality of programming loops to store a single bit of data in each memory cell of the selected word line. The programming loops include programming operations and verify operations. The programming operations include applying a programming voltage to the selected word line, and the verify operations include applying a verify voltage to the selected word line. At least one programming loop of the plurality of programming loops further includes a pre-verify operation. The pre-verify operation includes applying a pre-read voltage to the selected word line. The pre-read voltage is less than the verify voltage.

According to another aspect of the present disclosure, the control circuitry is configured to only include the pre-verify operation in a first programming loop of the plurality of programming loops.

According to yet another aspect of the present disclosure, the control circuitry is configured to only include the pre-verify operation in a first programming loop of the plurality of programming loops.

According to still another aspect of the present disclosure, the control circuitry is configured such that, in the first programming loop of the plurality of programming loops, a set of low threshold voltage memory cells that have threshold voltages that are less than the pre-read voltage are identified in the pre-verify operation, and only the set of low threshold voltage memory cells are programmed during the programming operation.

According to a further aspect of the present disclosure, the control circuitry is configured such that at least a first programming loop and a second programming loop of the plurality of programming loops include pre-verify operations.

According to yet a further aspect of the present disclosure, the control circuitry is configured such that the pre-read voltage that is applied to the selected word line during the first programming loop is a first pre-read voltage, and the pre-read voltage that is applied to the selected word line during the second programming loop is a second pre-read voltage. The second pre-read voltage is greater than the first pre-read voltage.

According to still a further aspect of the present disclosure, the control circuitry is configured such that, during the pre-verify operation of at least the first programming loop and the second programming loop, a set of low threshold voltage memory cells that have threshold voltages that are less than the pre-read voltage are identified, and the control circuitry locks out the set of low threshold voltage memory cells during the verify operations of at least the first programming loop and the second programming loop.

According to another aspect of the present disclosure, the control circuitry determines the pre-read voltage as a function of the verify voltage.

According to yet another aspect of the present disclosure, the control circuitry is configured to track lifetime program-erase cycles of the storage device and automatically increases the verify voltage with increasing program-erase cycles.

According to still another aspect of the present disclosure, the non-volatile memory only includes a single power input that is greater than 1.5 V.

Still another aspect of the present disclosure is related to an apparatus that includes a non-volatile memory device with a programming means for programming a single bit of data into each memory cell of a plurality of memory cells arranged in a plurality of word lines. The programming means is configured to program the memory cells of a selected word line of the plurality of word lines in a plurality of programming loops. The programming loops include programming operations and verify operations. The programming operations include applying a programming voltage to the selected word line, and the verify operations include applying a verify voltage to the selected word line. At least one of the programming loops also includes a pre-verify operation, which includes applying a pre-read voltage to the selected word line. The pre-read voltage is less than the verify voltage. During the at least one programming loop that includes the pre-verify operation, the programming operation or the verify operation is adjusted based on results of the pre-verify operation.

According to another aspect of the present disclosure, the non-volatile memory device only includes a single power input that is no greater than 1.5 V.

### BRIEF DESCRIPTION OF THE DRAWINGS

A more detailed description is set forth below with reference to example embodiments depicted in the appended figures. Understanding that these figures depict only example embodiments of the disclosure and are, therefore, not to be considered limiting of its scope. The disclosure is described and explained with added specificity and detail through the use of the accompanying drawings in which:

FIG. 1A is a block diagram of an example memory device;

FIG. 1B is a block diagram of an example control circuit;

FIG. 2 depicts blocks of memory cells in an example two-dimensional configuration of the memory array of FIG. 1A;

FIG. 3A and FIG. 3B depict cross-sectional views of example floating gate memory cells in NAND strings;

FIG. 4A and FIG. 4B depict cross-sectional views of example charge-trapping memory cells in NAND strings;

FIG. 5 depicts an example block diagram of the sense block SB1 of FIG. 1;

FIG. 6A is a perspective view of a set of blocks in an example three-dimensional configuration of the memory array of FIG. 1;

FIG. 6B depicts an example cross-sectional view of a portion of one of the blocks of FIG. 6A;

FIG. 6C depicts a plot of memory hole diameter in the stack of FIG. 6B;

FIG. 6D depicts a close-up view of region 722 of the stack of FIG. 6B;

FIG. 7A depicts a top view of an example word line layer WLL0 of the stack of FIG. 6B;

FIG. 7B depicts a top view of an example top dielectric layer DL19 of the stack of FIG. 6B;

FIG. 8A depicts example NAND strings in the sub-blocks SBa-SBd of FIG. 7A;

FIG. 8B depicts another example view of NAND strings in sub-blocks;

FIG. 9 illustrates the Vth distributions of the data states in an SLC memory system;

FIG. 10 is a schematic view of an exemplary memory device;

FIG. 11A is a schematic view of a string during a programming operation;

FIG. 11B is a schematic view of the string during an inhibit operation;

FIG. 12A is a flow chart illustrating the steps of a first exemplary method of operating a memory device;

FIG. 12B is a look-up table for determining a pre-read voltage to be used in the method of FIG. 12A;

FIG. 13A illustrates a threshold voltage distribution of the memory cells of a selected word line before a programming operation begins;

FIG. 13B illustrates the threshold distribution of the memory cells of the selected word line after a first programming loop;

FIG. 13C illustrates the threshold distribution of the memory cells of the selected word line after a second programming loop;

FIG. 14 illustrates a voltage waveform of the voltage applied to a selected word line during the programming operation depicted in FIG. 12A;

FIG. 15 is a flow chart illustrating the steps of a second exemplary method of operating a memory device;

FIG. 16A illustrates a threshold voltage distribution of the memory cells of a selected word line before a programming operation begins;

FIG. 16B illustrates a threshold voltage distribution of the memory cells of the selected word line after a pre-verify operation of a first programming loop;

FIG. 16C illustrates a threshold voltage distribution of the memory cells of the selected word line after a programming operation of the first programming loop;

FIG. 16D illustrates a threshold voltage distribution of the memory cells of the selected word line after a programming operation of a second programming loop;

FIG. 17A is a flow chart illustrating the steps of a third exemplary method of operating a memory device;

FIG. 17B is a look-up table correlating a verify voltage to a cycle number for use during the method depicted in the flow chart of FIG. 17A;

FIG. 18A illustrates a voltage threshold distribution of the memory cells of a selected word line following a programming operation in a new memory device;

FIG. 18B illustrates the voltage threshold distribution of the memory cells depicted in FIG. 18A but following a predetermined period of time;

FIG. 19A illustrates a voltage threshold distribution of the memory cells of a selected word line following a programming operation in a memory device that has experienced a first number of program-erase cycles;

FIG. 19B illustrates the voltage threshold distribution of the memory cells depicted in FIG. 19A but following a predetermined period of time;

FIG. 20A illustrates a voltage threshold distribution of the memory cells of a selected word line following a programming operation in a memory device that has experienced a second number of program-erase cycles; and

FIG. 20B illustrates the voltage threshold distribution of the memory cells depicted in FIG. 20A but following a predetermined period of time.

### DETAILED DESCRIPTION

Techniques are provided for programming a non-volatile memory device, such as of the type having a NAND architecture, that may be optimized for use in the mining of certain types of cryptocurrencies. However, it should be appreciated that the benefits afforded by the programming techniques discussed below may find uses in applications beyond cryptocurrency mining.

The use of SSDs in the mining of certain types of cryptocurrencies may include a very high frequency of programming and erasing data as compared to most consumer uses of SSDs. This is particularly pronounced if the SSD is employed as a high-speed buffer for generating plots of data that are later moved to long-term storage on another storage device, e.g., an HDD. Thus, for such applications, endurance (the ability to program and erase the memory cells many times) is especially important. One measure of grading the endurance of SSDs is with the unit Terabytes Write (TBW), which is the approximate total amount of data that can be written to the SSD over its estimated operating life.

One limiting factor to the endurance of an SSD is the number of program-erase cycles (the number of times a memory cell is programmed and then erased) a memory block experiences. More specifically, with each program-erase cycle, a dielectric layer of each memory cell may degrade very slightly and leak electrons, thereby causing the memory cells to lose charge. Over a large number of program-erase cycles, the degrading dielectric layer can impair data retention.

Another important factor in the mining of certain types of cryptocurrencies with SSDs is power consumption with the objective being to maximize the number of SSDs that can be operated in parallel with one another to increase cryptocurrency mining capacity within the limits of certain power supplies. For example, if a power supply has an available capacity of 100 W and each SSD consumes 10 W, then no more than ten SSDs can be operated in parallel at any time. Conversely, twenty SSDs that consume 5 W of power can be operated in parallel by the same power supply.

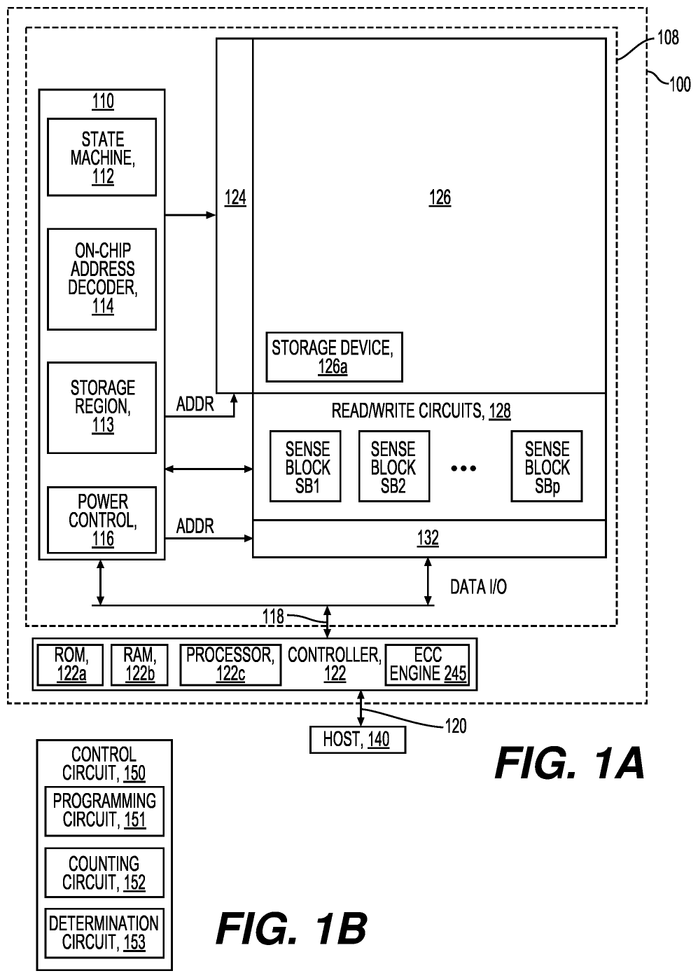

FIG. 1A is a block diagram of an example memory device. The memory device 100 may include one or more memory die 108. The memory die 108 includes a memory structure 126 of memory cells, such as an array of memory cells, control circuitry 110, and read/write circuits 128. The memory structure 126 is addressable by word lines via a row decoder 124 and by bit lines via a column decoder 132. The read/write circuits 128 include multiple sense blocks SB1, SB2, . . . SBp (sensing circuitry) and allow a page of memory cells to be read or programmed in parallel. Typically, a controller 122 is included in the same memory device 100 (e.g., a removable storage card) as the one or more memory die 108. Commands and data are transferred between the host 140 and controller 122 via a data bus 120, and between the controller and the one or more memory die 108 via lines 118.

The memory structure 126 can be two-dimensional or three-dimensional. The memory structure 126 may comprise one or more array of memory cells including a three-dimensional array. The memory structure 126 may comprise a monolithic three-dimensional memory structure in which multiple memory levels are formed above (and not in) a single substrate, such as a wafer, with no intervening substrates. The memory structure 126 may comprise any type of non-volatile memory that is monolithically formed in one or more physical levels of arrays of memory cells having an active area disposed above a silicon substrate. The memory structure 126 may be in a non-volatile memory device having circuitry associated with the operation of the memory cells, whether the associated circuitry is above or within the substrate.

The control circuitry 110 cooperates with the read/write circuits 128 to perform memory operations on the memory structure 126, and includes a state machine 112, an on-chip address decoder 114, and a power control module 116. The state machine 112 provides chip-level control of memory operations.

A storage region 113 may, for example, be provided for programming parameters. The programming parameters may include a program voltage, a program voltage bias, position parameters indicating positions of memory cells, contact line connector thickness parameters, a verify voltage, and/or the like. The position parameters may indicate a position of a memory cell within the entire array of NAND strings, a position of a memory cell as being within a particular NAND string group, a position of a memory cell on a particular plane, and/or the like. The contact line connector thickness parameters may indicate a thickness of a contact line connector, a substrate or material that the contact line connector is comprised of, and/or the like.

The on-chip address decoder 114 provides an address interface between that used by the host or a memory controller to the hardware address used by the decoders 124 and 132. The power control module 116 controls the power and voltages supplied to the word lines and bit lines during memory operations. It can include drivers for word lines, SGS and SGD transistors, and source lines. The sense blocks can include bit line drivers, in one approach. An SGS transistor is a select gate transistor at a source end of a NAND string, and an SGD transistor is a select gate transistor at a drain end of a NAND string.

In some embodiments, some of the components can be combined. In various designs, one or more of the components (alone or in combination), other than memory structure 126, can be thought of as at least one control circuit which is configured to perform the actions described herein. For example, a control circuit may include any one of, or a combination of, control circuitry 110, state machine 112, decoders 114/132, power control module 116, sense blocks SBb, SB2, . . . , SBp, read/write circuits 128, controller 122, and so forth.

The control circuits can include a programming circuit configured to perform a program and verify operation for one set of memory cells, wherein the one set of memory cells comprises memory cells assigned to represent one data state among a plurality of data states and memory cells assigned to represent another data state among the plurality of data states; the program and verify operation comprising a plurality of program and verify iterations; and in each program and verify iteration, the programming circuit performs programming for the one selected word line after which the programming circuit applies a verification signal to the selected word line. The control circuits can also include a counting circuit configured to obtain a count of memory cells which pass a verify test for the one data state. The control circuits can also include a determination circuit configured to determine, based on an amount by which the count exceeds a threshold, if a programming operation is completed.

For example, FIG. 1B is a block diagram of an example control circuit 150 which comprises a programming circuit 151, a counting circuit 152, and a determination circuit 153.

The off-chip controller 122 may comprise a processor 122c, storage devices (memory) such as ROM 122a and RAM 122b and an error-correction code (ECC) engine 245. The ECC engine can correct a number of read errors which are caused when the upper tail of a Vth distribution becomes too high. However, uncorrectable errors may exist in some cases. The techniques provided herein reduce the likelihood of uncorrectable errors.

The storage device(s) 122a, 122b comprise, code such as a set of instructions, and the processor 122c is operable to execute the set of instructions to provide the functionality described herein. Alternately or additionally, the processor 122c can access code from a storage device 126a of the memory structure 126, such as a reserved area of memory cells in one or more word lines. For example, code can be used by the controller 122 to access the memory structure 126 such as for programming, read and erase operations. The code can include boot code and control code (e.g., set of instructions). The boot code is software that initializes the controller 122 during a booting or startup process and enables the controller 122 to access the memory structure 126. The code can be used by the controller 122 to control one or more memory structures 126. Upon being powered up, the processor 122c fetches the boot code from the ROM 122a or storage device 126a for execution, and the boot code initializes the system components and loads the control code into the RAM 122b. Once the control code is loaded into the RAM 122b, it is executed by the processor 122c. The control code includes drivers to perform basic tasks such as controlling and allocating memory, prioritizing the processing of instructions, and controlling input and output ports.

Generally, the control code can include instructions to perform the functions described herein including the steps of the flowcharts discussed further below and provide the voltage waveforms including those discussed further below.

In one embodiment, the host is a computing device (e.g., laptop, desktop, smartphone, tablet, digital camera) that includes one or more processors, one or more processor readable storage devices (RAM, ROM, flash memory, hard disk drive, solid state memory) that store processor readable code (e.g., software) for programming the one or more processors to perform the methods described herein. The host may also include additional system memory, one or more input/output interfaces and/or one or more input/output devices in communication with the one or more processors.

Other types of non-volatile memory in addition to NAND flash memory can also be used.

Semiconductor memory devices include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse or phase change material, and optionally a steering element, such as a diode or transistor. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND string is an example of a set of series-connected transistors comprising memory cells and SG transistors.

A NAND memory array may be configured so that the array is composed of multiple memory strings in which a string is composed of multiple memory elements sharing a single bit line and accessed as a group. Alternatively, memory elements may be configured so that each element is individually accessible, e.g., a NOR memory array. NAND and NOR memory configurations are examples, and memory elements may be otherwise configured. The semiconductor memory elements located within and/or over a substrate may be arranged in two or three dimensions, such as a two-dimensional memory structure or a three-dimensional memory structure.

In a two-dimensional memory structure, the semiconductor memory elements are arranged in a single plane or a single memory device level. Typically, in a two-dimensional memory structure, memory elements are arranged in a plane (e.g., in an x-y direction plane) which extends substantially parallel to a major surface of a substrate that supports the memory elements. The substrate may be a wafer over or in which the layer of the memory elements is formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and word lines.

A three-dimensional memory array is arranged so that memory elements occupy multiple planes or multiple memory device levels, thereby forming a structure in three dimensions (i.e., in the x, y and z directions, where the z-direction is substantially perpendicular and the x- and y-directions are substantially parallel to the major surface of the substrate).

As a non-limiting example, a three-dimensional memory structure may be vertically arranged as a stack of multiple two-dimensional memory device levels. As another non-limiting example, a three-dimensional memory array may be arranged as multiple vertical columns (e.g., columns extending substantially perpendicular to the major surface of the substrate, i.e., in the y direction) with each column having multiple memory elements. The columns may be arranged in a two-dimensional configuration, e.g., in an x-y plane, resulting in a three-dimensional arrangement of memory elements with elements on multiple vertically stacked memory planes. Other configurations of memory elements in three dimensions can also constitute a three-dimensional memory array.

By way of non-limiting example, in a three-dimensional array of NAND strings, the memory elements may be coupled together to form a NAND string within a single horizontal (e.g., x-y) memory device level. Alternatively, the memory elements may be coupled together to form a vertical NAND string that traverses across multiple horizontal memory device levels. Other three-dimensional configurations can be envisioned wherein some NAND strings contain memory elements in a single memory level while other strings contain memory elements which span through multiple memory levels. Three-dimensional memory arrays may also be designed in a NOR configuration and in a ReRAM configuration.

Typically, in a monolithic three-dimensional memory array, one or more memory device levels are formed above a single substrate. Optionally, the monolithic three-dimensional memory array may also have one or more memory layers at least partially within the single substrate. As a non-limiting example, the substrate may include a semiconductor such as silicon. In a monolithic three-dimensional array, the layers constituting each memory device level of the array are typically formed on the layers of the underlying memory device levels of the array. However, layers of adjacent memory device levels of a monolithic three-dimensional memory array may be shared or have intervening layers between memory device levels.

Then again, two-dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three-dimensional memory arrays. Further, multiple two-dimensional memory arrays or three-dimensional memory arrays (monolithic or non-monolithic) may be formed on separate chips and then packaged together to form a stacked-chip memory device.

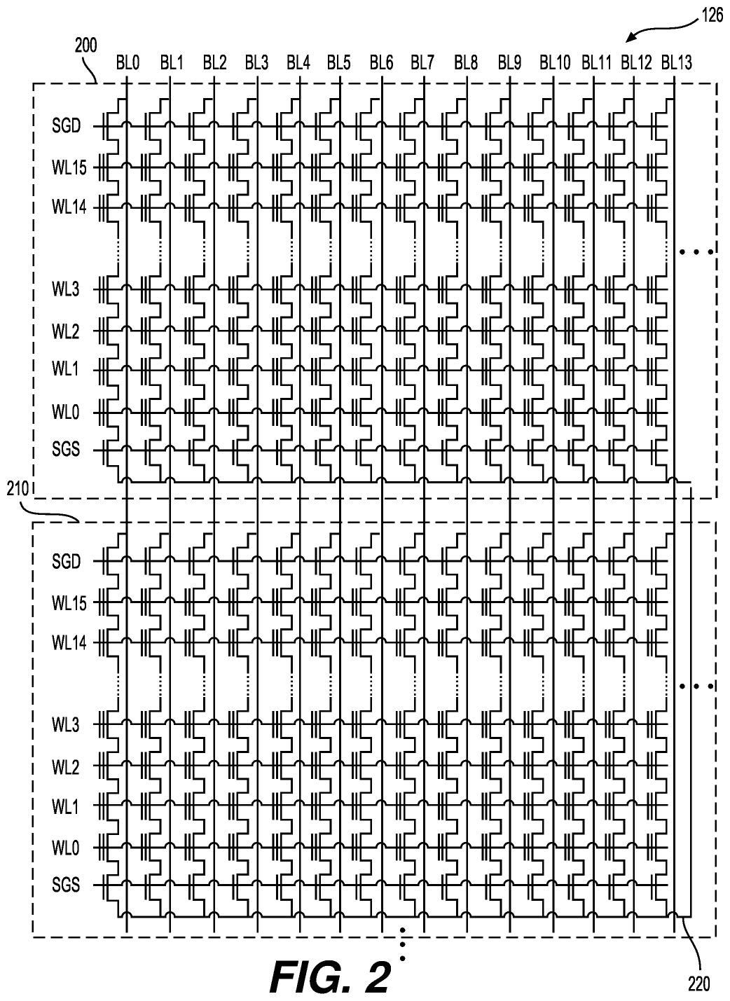

FIG. 2 illustrates schematic views of three types of memory architectures utilizing staggered memory strings. For example, reference number 201 shows a schematic view of a first example memory architecture, reference number 203 shows a schematic view of a second example memory architecture, and reference number 205 shows a schematic view of a third example memory architecture. In some embodiments, as shown, the memory architecture may include an array of staggered NAND strings.

FIG. 2 illustrates blocks 200, 210 of memory cells in an example two-dimensional configuration of the memory array 126 of FIG. 1. The memory array 126 can include many such blocks 200, 210. Each example block 200, 210 includes a number of NAND strings and respective bit lines, e.g., BL0, BL1, . . . which are shared among the blocks. Each NAND string is connected at one end to a drain-side select gate (SGD), and the control gates of the drain select gates are connected via a common SGD line. The NAND strings are connected at their other end to a source-side select gate (SGS) which, in turn, is connected to a common source line 220. Sixteen word lines, for example, WL0-WL15, extend between the SGSs and the SGDs. In some cases, dummy word lines, which contain no user data, can also be used in the memory array adjacent to the select gate transistors. Such dummy word lines can shield the edge data word line from certain edge effects.

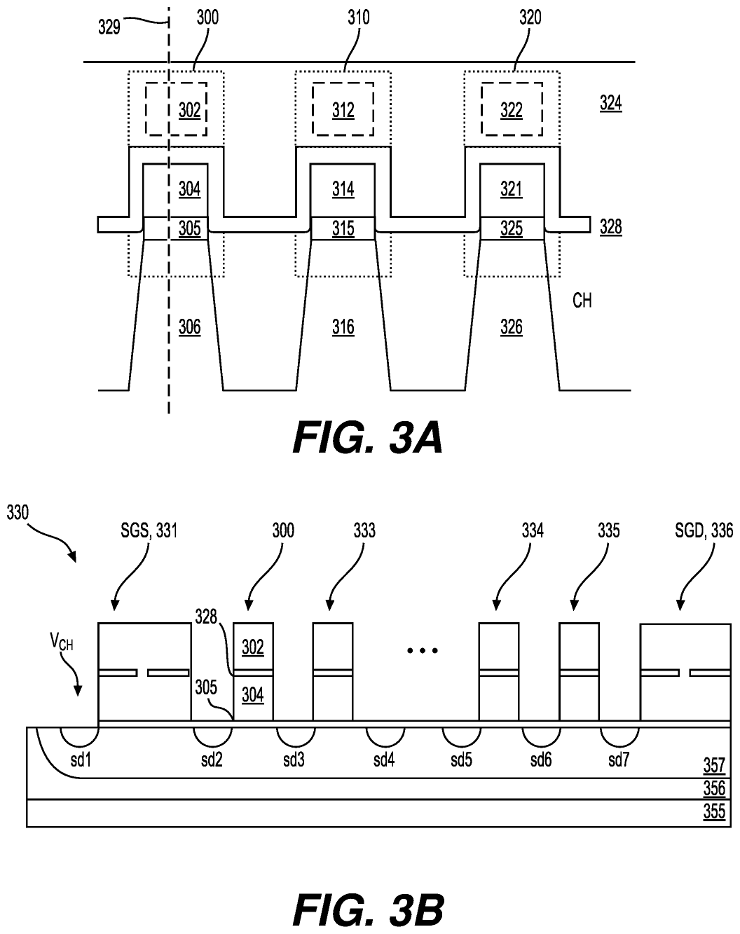

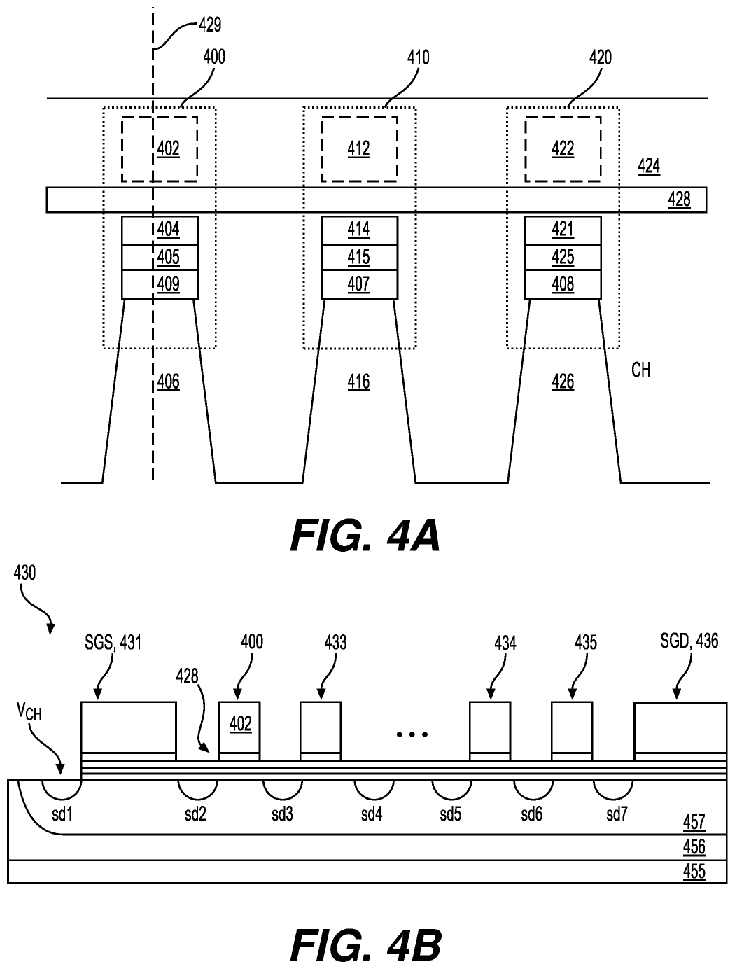

One type of non-volatile memory which may be provided in the memory array is a floating gate memory, such as of the type shown in FIGS. 3A and 3B. However, other types of non-volatile memory can also be used. As discussed in further detail below, in another example shown in FIGS. 4A and 4B, a charge-trapping memory cell uses a non-conductive dielectric material in place of a conductive floating gate to store charge in a non-volatile manner. A triple layer dielectric formed of silicon oxide, silicon nitride and silicon oxide (“ONO”) is sandwiched between a conductive control gate and a surface of a semi-conductive substrate above the memory cell channel. The cell is programmed by injecting electrons from the cell channel into the nitride, where they are trapped and stored in a limited region. This stored charge then changes the threshold voltage of a portion of the channel of the cell in a manner that is detectable. The cell is erased by injecting hot holes into the nitride. A similar cell can be provided in a split-gate configuration where a doped polysilicon gate extends over a portion of the memory cell channel to form a separate select transistor.

In another approach, NROM cells are used. Two bits, for example, are stored in each NROM cell, where an ONO dielectric layer extends across the channel between source and drain diffusions. The charge for one data bit is localized in the dielectric layer adjacent to the drain, and the charge for the other data bit localized in the dielectric layer adjacent to the source. Multi-state data storage is obtained by separately reading binary states of the spatially separated charge storage regions within the dielectric. Other types of non-volatile memory are also known.

FIG. 3A illustrates a cross-sectional view of example floating gate memory cells 300, 310, 320 in NAND strings. In this Figure, a bit line or NAND string direction goes into the page, and a word line direction goes from left to right. As an example, word line 324 extends across NAND strings which include respective channel regions 306, 316 and 326. The memory cell 300 includes a control gate 302, a floating gate 304, a tunnel oxide layer 305 and the channel region 306. The memory cell 310 includes a control gate 312, a floating gate 314, a tunnel oxide layer 315 and the channel region 316. The memory cell 320 includes a control gate 322, a floating gate 321, a tunnel oxide layer 325 and the channel region 326. Each memory cell 300, 310, 320 is in a different respective NAND string. An inter-poly dielectric (IPD) layer 328 is also illustrated. The control gates 302, 312, 322 are portions of the word line. A cross-sectional view along contact line connector 329 is provided in FIG. 3B.

The control gate 302, 312, 322 wraps around the floating gate 304, 314, 321, increasing the surface contact area between the control gate 302, 312, 322 and floating gate 304, 314, 321. This results in higher IPD capacitance, leading to a higher coupling ratio which makes programming and erase easier. However, as NAND memory devices are scaled down, the spacing between neighboring cells 300, 310, 320 becomes smaller so there is almost no space for the control gate 302, 312, 322 and the IPD layer 328 between two adjacent floating gates 302, 312, 322.

As an alternative, as shown in FIGS. 4A and 4B, the flat or planar memory cell 400, 410, 420 has been developed in which the control gate 402, 412, 422 is flat or planar; that is, it does not wrap around the floating gate and its only contact with the charge storage layer 428 is from above it. In this case, there is no advantage in having a tall floating gate. Instead, the floating gate is made much thinner. Further, the floating gate can be used to store charge, or a thin charge trap layer can be used to trap charge. This approach can avoid the issue of ballistic electron transport, where an electron can travel through the floating gate after tunneling through the tunnel oxide during programming.

FIG. 4A depicts a cross-sectional view of example charge-trapping memory cells 400, 410, 420 in NAND strings. The view is in a word line direction of memory cells 400, 410, 420 comprising a flat control gate and charge-trapping regions as a two-dimensional example of memory cells 400, 410, 420 in the memory cell array 126 of FIG. 1. Charge-trapping memory can be used in NOR and NAND flash memory device. This technology uses an insulator such as an SiN film to store electrons, in contrast to a floating-gate MOSFET technology which uses a conductor such as doped polycrystalline silicon to store electrons. As an example, a word line 424 extends across NAND strings which include respective channel regions 406, 416, 426. Portions of the word line provide control gates 402, 412, 422. Below the word line is an IPD layer 428, charge-trapping layers 404, 414, 421, polysilicon layers 405, 415, 425, and tunneling layers 409, 407, 408. Each charge-trapping layer 404, 414, 421 extends continuously in a respective NAND string. The flat configuration of the control gate can be made thinner than a floating gate. Additionally, the memory cells can be placed closer together.

FIG. 4B illustrates a cross-sectional view of the structure of FIG. 4A along contact line connector 429. The NAND string 430 includes an SGS transistor 431, example memory cells 400, 433, . . . 435, and an SGD transistor 436. Passageways in the IPD layer 428 in the SGS and SGD transistors 431, 436 allow the control gate layers 402 and floating gate layers to communicate. The control gate 402 and floating gate layers may be polysilicon and the tunnel oxide layer may be silicon oxide, for instance. The IPD layer 428 can be a stack of nitrides (N) and oxides (0) such as in a N-O-N-O-N configuration.

The NAND string may be formed on a substrate which comprises a p-type substrate region 455, an n-type well 456 and a p-type well 457. N-type source/drain diffusion regions sd1, sd2, sd3, sd4, sd5, sd6 and sd7 are formed in the p-type well. A channel voltage, Vch, may be applied directly to the channel region of the substrate.

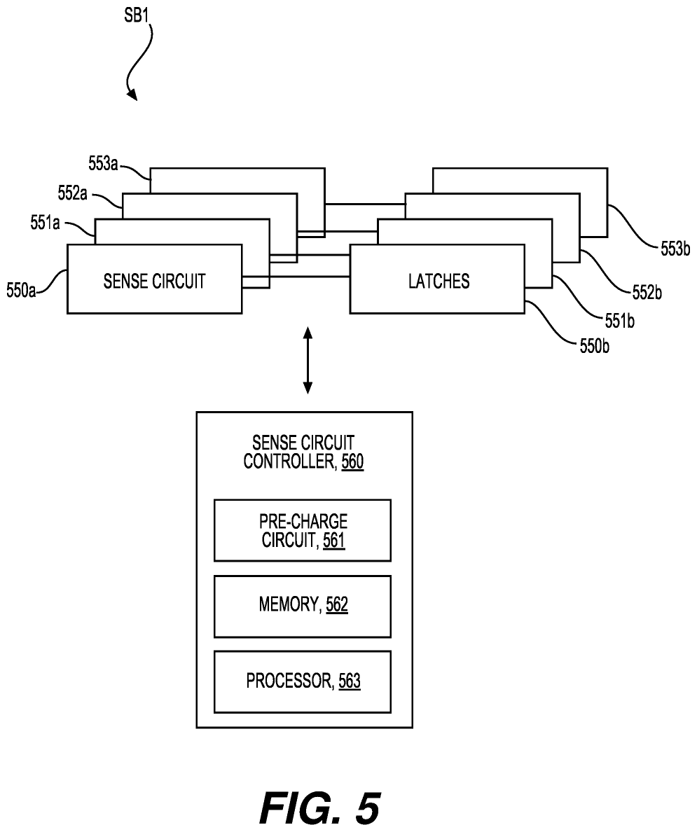

FIG. 5 illustrates an example block diagram of the sense block SB1 of FIG. 1. In one approach, a sense block comprises multiple sense circuits. Each sense circuit is associated with data latches. For example, the example sense circuits 550a, 551a, 552a, and 553a are associated with the data latches 550b, 551b, 552b, and 553b, respectively. In one approach, different subsets of bit lines can be sensed using different respective sense blocks. This allows the processing load which is associated with the sense circuits to be divided up and handled by a respective processor in each sense block. For example, a sense circuit controller 560 in SB1 can communicate with the set of sense circuits and latches. The sense circuit controller 560 may include a pre-charge circuit 561 which provides a voltage to each sense circuit for setting a pre-charge voltage. In one possible approach, the voltage is provided to each sense circuit independently, e.g., via the data bus and a local bus. In another possible approach, a common voltage is provided to each sense circuit concurrently. The sense circuit controller 560 may also include a pre-charge circuit 561, a memory 562 and a processor 563. The memory 562 may store code which is executable by the processor to perform the functions described herein. These functions can include reading the latches 550b, 551b, 552b, 553b which are associated with the sense circuits 550a, 551a, 552a, 553a, setting bit values in the latches and providing voltages for setting pre-charge levels in sense nodes of the sense circuits 550a, 551a, 552a, 553a. Further example details of the sense circuit controller 560 and the sense circuits 550a, 551a, 552a, 553a are provided below.

In some embodiments, a memory cell may include a flag register that includes a set of latches storing flag bits. In some embodiments, a quantity of flag registers may correspond to a quantity of data states. In some embodiments, one or more flag registers may be used to control a type of verification technique used when verifying memory cells. In some embodiments, a flag bit's output may modify associated logic of the device, e.g., address decoding circuitry, such that a specified block of cells is selected. A bulk operation (e.g., an erase operation, etc.) may be carried out using the flags set in the flag register, or a combination of the flag register with the address register, as in implied addressing, or alternatively by straight addressing with the address register alone.

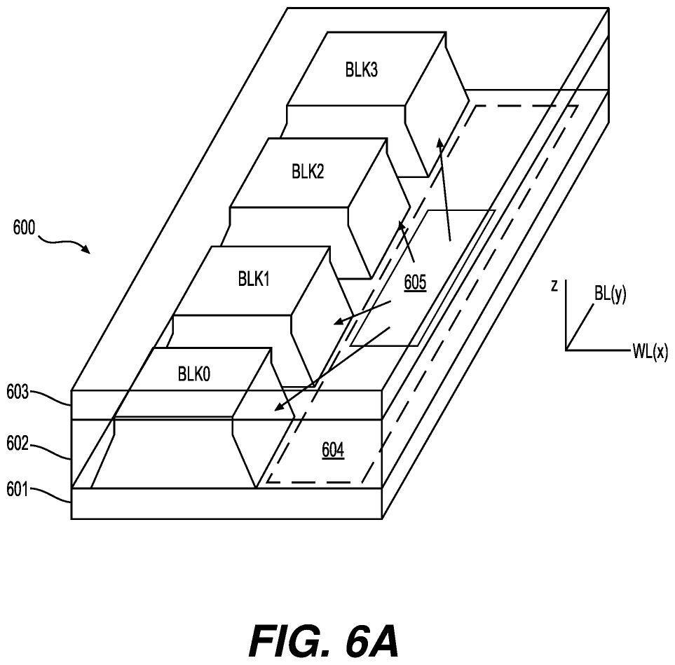

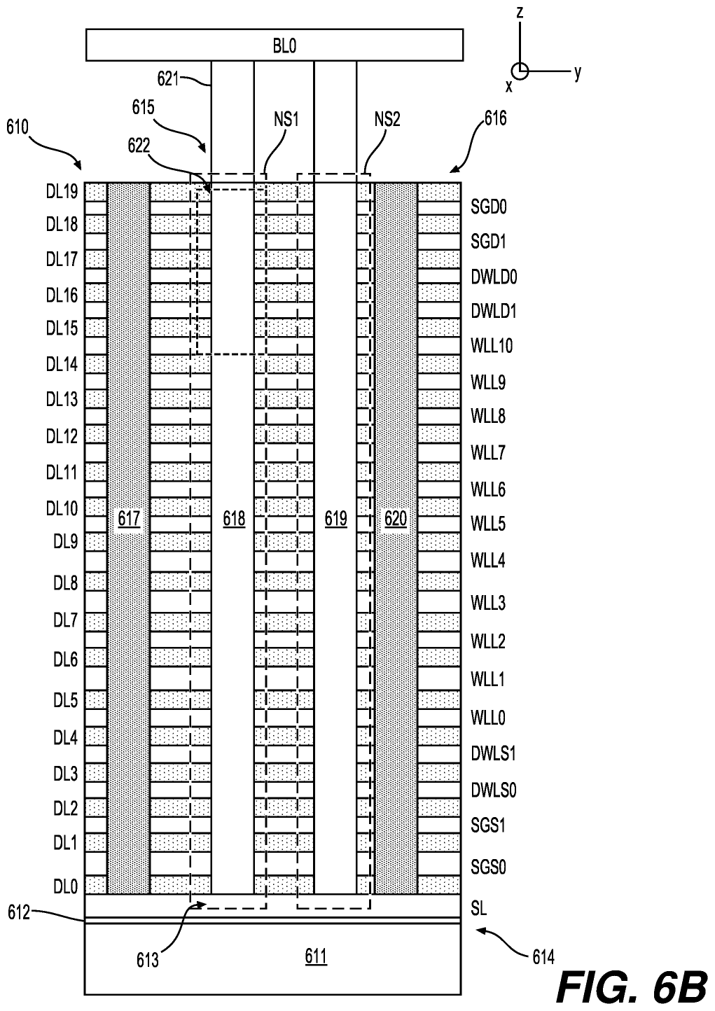

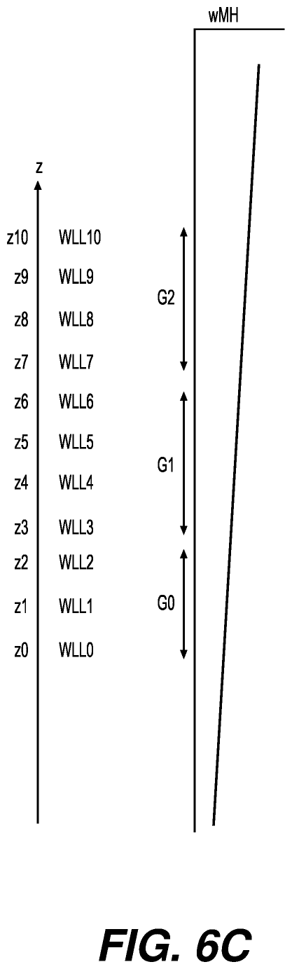

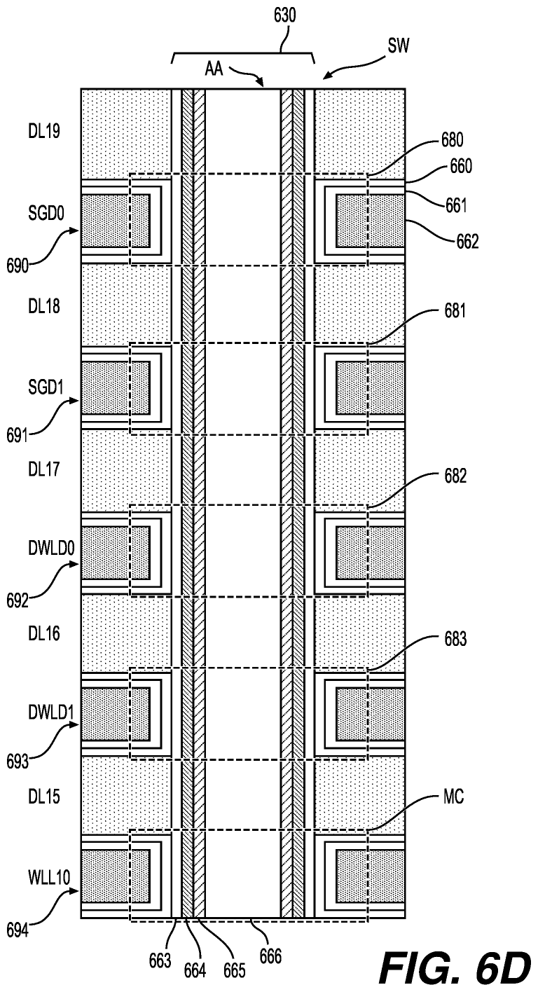

FIG. 6A is a perspective view of a set of blocks 600 in an example three-dimensional configuration of the memory array 126 of FIG. 1. On the substrate are example blocks BLK0, BLK1, BLK2, BLK3 of memory cells (storage elements) and a peripheral area 604 with circuitry for use by the blocks BLK0, BLK1, BLK2, BLK3. For example, the circuitry can include voltage drivers 605 which can be connected to control gate layers of the blocks BLK0, BLK1, BLK2, BLK3. In one approach, control gate layers at a common height in the blocks BLK0, BLK1, BLK2, BLK3 are commonly driven. The substrate 601 can also carry circuitry under the blocks BLK0, BLK1, BLK2, BLK3, along with one or more lower metal layers which are patterned in conductive paths to carry signals of the circuitry. The blocks BLK0, BLK1, BLK2, BLK3 are formed in an intermediate region 602 of the memory device. In an upper region 603 of the memory device, one or more upper metal layers are patterned in conductive paths to carry signals of the circuitry. Each block BLK0, BLK1, BLK2, BLK3 comprises a stacked area of memory cells, where alternating levels of the stack represent word lines. In one possible approach, each block BLK0, BLK1, BLK2, BLK3 has opposing tiered sides from which vertical contacts extend upward to an upper metal layer to form connections to conductive paths. While four blocks BLK0, BLK1, BLK2, BLK3 are illustrated as an example, two or more blocks can be used, extending in the x- and/or y-directions.

In one possible approach, the length of the plane, in the x-direction, represents a direction in which signal paths to word lines extend in the one or more upper metal layers (a word line or SGD line direction), and the width of the plane, in the y-direction, represents a direction in which signal paths to bit lines extend in the one or more upper metal layers (a bit line direction). The z-direction represents a height of the memory device.

FIG. 6B illustrates an example cross-sectional view of a portion of one of the blocks BLK0, BLK1, BLK2, BLK3 of FIG. 6A. The block comprises a stack 610 of alternating conductive and dielectric layers. In this example, the conductive layers comprise two SGD layers, two SGS layers and four dummy word line layers DWLD0, DWLD1, DWLS0 and DWLS1, in addition to data word line layers (word lines) WLL0-WLL10. The dielectric layers are labelled as DL0-DL19. Further, regions of the stack 610 which comprise NAND strings NS1 and NS2 are illustrated. Each NAND string encompasses a memory hole 618, 619 which is filled with materials which form memory cells adjacent to the word lines. A region 622 of the stack 610 is shown in greater detail in FIG. 6D and is discussed in further detail below.

The 610 stack includes a substrate 611, an insulating film 612 on the substrate 611, and a portion of a source line SL. NS1 has a source-end 613 at a bottom 614 of the stack and a drain-end 615 at a top 616 of the stack 610. Contact line connectors (e.g., slits, such as metal-filled slits) 617, 620 may be provided periodically across the stack 610 as interconnects which extend through the stack 610, such as to connect the source line to a particular contact line above the stack 610. The contact line connectors 617, 620 may be used during the formation of the word lines and subsequently filled with metal. A portion of a bit line BL0 is also illustrated. A conductive via 621 connects the drain-end 615 to BL0.

FIG. 6C illustrates a plot of memory hole diameter in the stack of FIG. 6B. The vertical axis is aligned with the stack of FIG. 6B and illustrates a width (wMH), e.g., diameter, of the memory holes 618 and 619. The word line layers WLL0-WLL10 of FIG. 6A are repeated as an example and are at respective heights z0-z10 in the stack. In such a memory device, the memory holes which are etched through the stack have a very high aspect ratio. For example, a depth-to-diameter ratio of about 25-30 is common. The memory holes may have a circular cross-section. Due to the etching process, the memory hole width can vary along the length of the hole. Typically, the diameter becomes progressively smaller from the top to the bottom of the memory hole. That is, the memory holes are tapered, narrowing at the bottom of the stack. In some cases, a slight narrowing occurs at the top of the hole near the select gate so that the diameter becomes slightly wider before becoming progressively smaller from the top to the bottom of the memory hole.

Due to the non-uniformity in the width of the memory hole, the programming speed, including the program slope and erase speed of the memory cells can vary based on their position along the memory hole, e.g., based on their height in the stack. With a smaller diameter memory hole, the electric field across the tunnel oxide is relatively stronger, so that the programming and erase speed is relatively higher. One approach is to define groups of adjacent word lines for which the memory hole diameter is similar, e.g., within a defined range of diameter, and to apply an optimized verify scheme for each word line in a group. Different groups can have different optimized verify schemes.

FIG. 6D illustrates a close-up view of the region 622 of the stack 610 of FIG. 6B. Memory cells are formed at the different levels of the stack at the intersection of a word line layer and a memory hole. In this example, SGD transistors 680, 681 are provided above dummy memory cells 682, 683 and a data memory cell MC. A number of layers can be deposited along the sidewall (SW) of the memory hole 630 and/or within each word line layer, e.g., using atomic layer deposition. For example, each column (e.g., the pillar which is formed by the materials within a memory hole 630) can include a charge-trapping layer or film 663 such as SiN or other nitride, a tunneling layer 664, a polysilicon body or channel 665, and a dielectric core 666. A word line layer can include a blocking oxide/block high-k material 660, a metal barrier 661, and a conductive metal 662 such as Tungsten as a control gate. For example, control gates 690, 691, 692, 693, and 694 are provided. In this example, all of the layers except the metal are provided in the memory hole 630. In other approaches, some of the layers can be in the control gate layer. Additional pillars are similarly formed in the different memory holes. A pillar can form a columnar active area (AA) of a NAND string.

When a memory cell is programmed, electrons are stored in a portion of the charge-trapping layer which is associated with the memory cell. These electrons are drawn into the charge-trapping layer from the channel, and through the tunneling layer. The Vth of a memory cell is increased in proportion to the amount of stored charge. During an erase operation, the electrons return to the channel.

Each of the memory holes 630 can be filled with a plurality of annular layers comprising a blocking oxide layer, a charge trapping layer 663, a tunneling layer 664 and a channel layer. A core region of each of the memory holes 630 is filled with a body material, and the plurality of annular layers are between the core region and the word line in each of the memory holes 630.

The NAND string can be considered to have a floating body channel because the length of the channel is not formed on a substrate. Further, the NAND string is provided by a plurality of word line layers above one another in a stack, and separated from one another by dielectric layers.

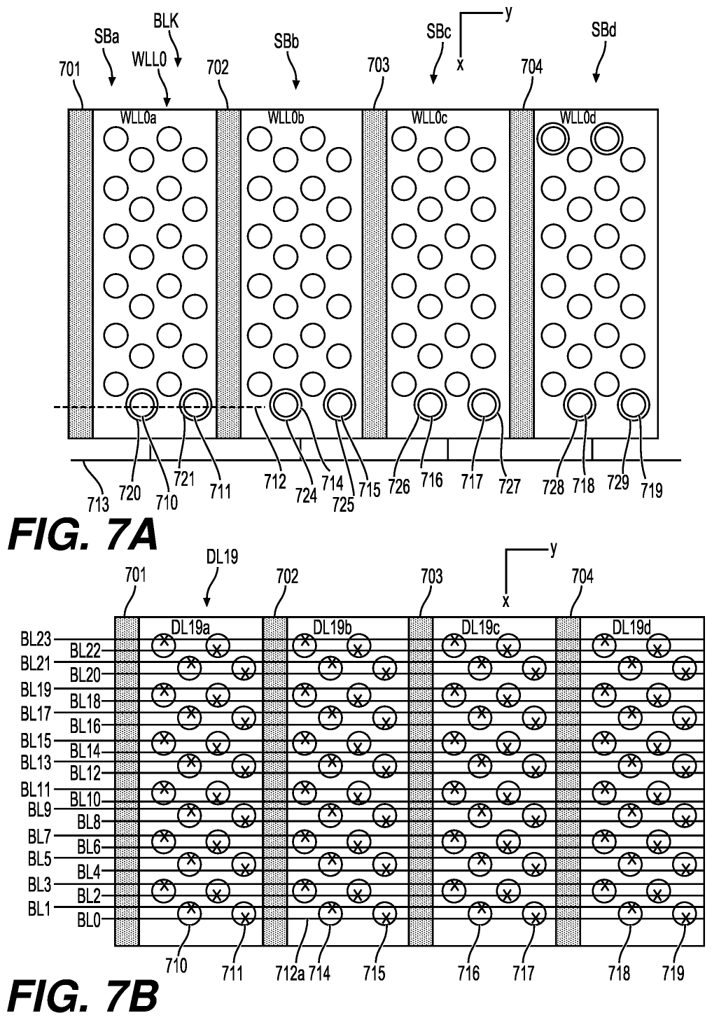

FIG. 7A illustrates a top view of an example word line layer WLL0 of the stack 610 of FIG. 6B. As mentioned, a three-dimensional memory device can comprise a stack of alternating conductive and dielectric layers. The conductive layers provide the control gates of the SG transistors and memory cells. The layers used for the SG transistors are SG layers and the layers used for the memory cells are word line layers. Further, memory holes are formed in the stack and filled with a charge-trapping material and a channel material. As a result, a vertical NAND string is formed. Source lines are connected to the NAND strings below the stack and bit lines are connected to the NAND strings above the stack.

A block BLK in a three-dimensional memory device can be divided into sub-blocks, where each sub-block comprises a NAND string group which has a common SGD control line. For example, see the SGD lines/control gates SGD0, SGD1, SGD2 and SGD3 in the sub-blocks SBa, SBb, SBc and SBd, respectively. Further, a word line layer in a block can be divided into regions. Each region is in a respective sub-block and can extend between contact line connectors (e.g., slits) which are formed periodically in the stack to process the word line layers during the fabrication process of the memory device. This processing can include replacing a sacrificial material of the word line layers with metal. Generally, the distance between contact line connectors should be relatively small to account for a limit in the distance that an etchant can travel laterally to remove the sacrificial material, and that the metal can travel to fill a void which is created by the removal of the sacrificial material. For example, the distance between contact line connectors may allow for a few rows of memory holes between adjacent contact line connectors. The layout of the memory holes and contact line connectors should also account for a limit in the number of bit lines which can extend across the region while each bit line is connected to a different memory cell. After processing the word line layers, the contact line connectors can optionally be filed with metal to provide an interconnect through the stack.

In this example, there are four rows of memory holes between adjacent contact line connectors. A row here is a group of memory holes which are aligned in the x-direction. Moreover, the rows of memory holes are in a staggered pattern to increase the density of the memory holes. The word line layer or word line is divided into regions WLL0 a, WLL0 b, WLL0 c and WLL0 d which are each connected by a contact line 713. The last region of a word line layer in a block can be connected to a first region of a word line layer in a next block, in one approach. The contact line 713, in turn, is connected to a voltage driver for the word line layer. The region WLL0a has example memory holes 710, 711 along a contact line 712. The region WLL0b has example memory holes 714, 715. The region WLL0c has example memory holes 716, 717. The region WLL0d has example memory holes 718, 719. The memory holes are also shown in FIG. 7B. Each memory hole can be part of a respective NAND string. For example, the memory holes 710, 714, 716 and 718 can be part of NAND strings NS0_SBa, NS1_SBb, NS2_SBc, NS3_SBd, and NS4_SBe, respectively.

Each circle represents the cross-section of a memory hole at a word line layer or SG layer. Example circles shown with dashed lines represent memory cells which are provided by the materials in the memory hole and by the adjacent word line layer. For example, memory cells 820, 821 are in WLL0a, memory cells 824, 825 are in WLL0b, memory cells 826, 827 are in WLL0c, and memory cells 828, 829 are in WLL0d. These memory cells are at a common height in the stack.

Contact line connectors (e.g., slits, such as metal-filled slits) 801, 802, 803, 804 may be located between and adjacent to the edges of the regions WLL0a-WLL0d. The contact line connectors 801, 802, 803, 804 provide a conductive path from the bottom of the stack to the top of the stack. For example, a source line at the bottom of the stack may be connected to a conductive line above the stack, where the conductive line is connected to a voltage driver in a peripheral region of the memory device.

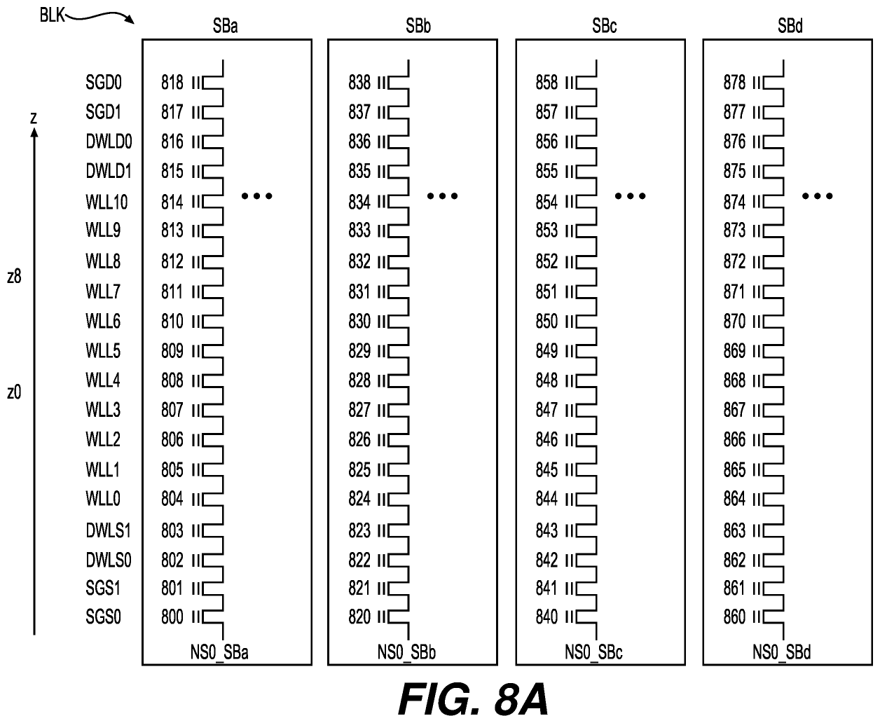

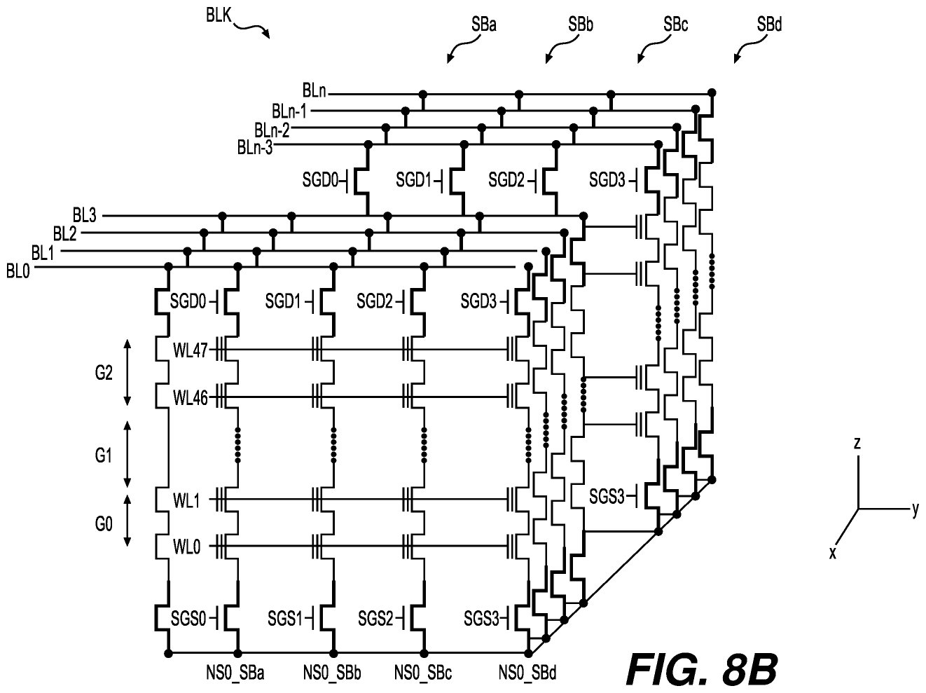

FIG. 8B illustrates a top view of an example top dielectric layer DL19 of the stack of FIG. 7B. The dielectric layer is divided into regions DL19a, DL19b, DL19c and DL19d. Each region can be connected to a respective voltage driver. This allows a set of memory cells in one region of a word line layer being programmed concurrently, with each memory cell being in a respective NAND string which is connected to a respective bit line. A voltage can be set on each bit line to allow or inhibit programming during each program voltage.

The region DL19a has the example memory holes 710, 711 along a contact line 712, which is coincident with a bit line BL0. A number of bit lines extend above the memory holes and are connected to the memory holes as indicated by the “X” symbols. BL0 is connected to a set of memory holes which includes the memory holes 711, 715, 717, 719. Another example bit line BL1 is connected to a set of memory holes which includes the memory holes 710, 714, 716, 718. The contact line connectors (e.g., slits, such as metal-filled slits) 701, 702, 703, 704 from FIG. 7A are also illustrated, as they extend vertically through the stack. The bit lines can be numbered in a sequence BL0-BL23 across the DL19 layer in the x-direction.

Different subsets of bit lines are connected to memory cells in different rows. For example, BL0, BL4, BL8, BL12, BL16, BL20 are connected to memory cells in a first row of cells at the right-hand edge of each region. BL2, BL6, BL10, BL14, BL18, BL22 are connected to memory cells in an adjacent row of cells, adjacent to the first row at the right-hand edge. BL3, BL7, BL11, BL15, BL19, BL23 are connected to memory cells in a first row of cells at the left-hand edge of each region. BL1, BL5, BL9, BL13, BL17, BL21 are connected to memory cells in an adjacent row of memory cells, adjacent to the first row at the left-hand edge.

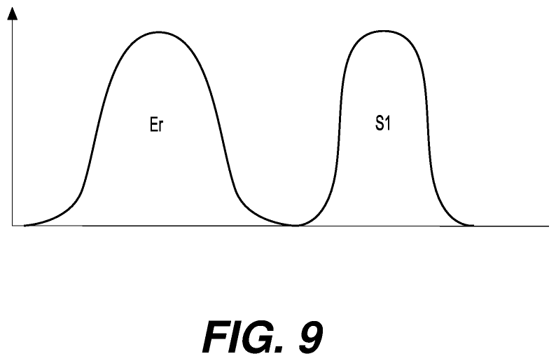

FIG. 9 depicts a threshold voltage Vt distribution of an SLC memory device whereby one bit of data is stored in each memory cell. That is, each memory cell may either be in an erased state (Er) representing either a “0 or a “1” or a programmed state 51 representing the other. Operating as an SLC memory device improves endurance of the SSD.

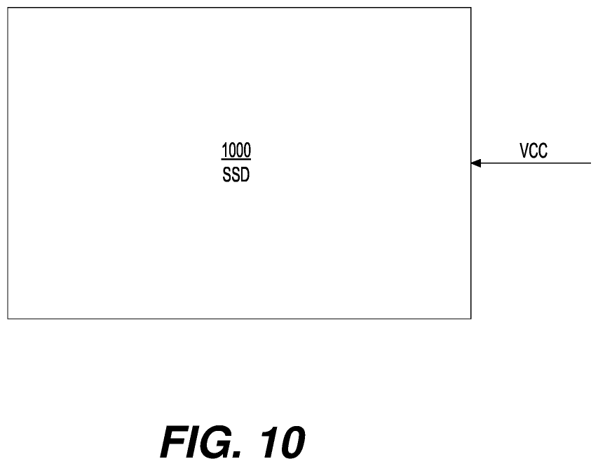

Referring now to FIG. 10, in the exemplary embodiment, the SSD 1000 has a single power input, which is maintained at a voltage referred to as Vcc during operation of the SSD. This is in contrast to many other known SSDs that have two power inputs, one at a high level to power most of the components of the SSD and one at a low level to power the transfer of data into and out of the SSD. The voltage of the single power input in the exemplary embodiment is at a magnitude which is comparable to the low power input of other known SSDs, yet in the SSD of the exemplary embodiment, this low voltage is able to power both the components of the SSD and the transfer of data into and out of the SSD. In some exemplary embodiments, Vcc is in the range of 1.0-1.5 V and is preferably approximately 1.2 V. The single low power input can be supplied to one or multiple pins on the SSD. In some embodiments, the SSD may include two or more different power supplies that are all at low voltage levels, e.g., one power input at 1.0 V and another power input at 1.5 V.

In order to allow the SSD to operate at the lower voltage (as compared to other known SSDs), the SSD is operated with three unique parameters. The first parameter is that during programming, the SSD cannot operate in a quick pass write (QPW) mode whereby a biasing voltage would be applied to certain bit lines coupled with memory cells being programmed to slow programming. The second parameter is that the maximum voltage threshold Vt of a programmed memory cell is relatively low by only operating the SSD in an SLC mode (one bit of data per memory cell). The third parameter is a unique pre-verify operation that is performed during programming and is discussed in further detail below.

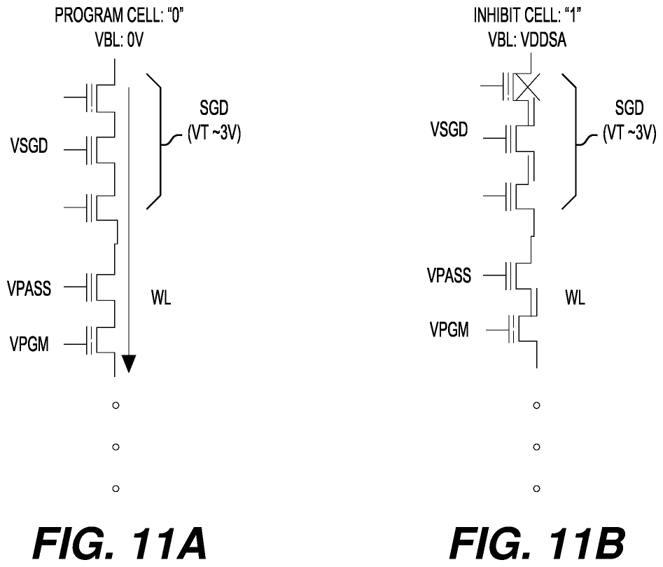

With regards to the aforementioned second parameter that allows the SSD to operate with the low input voltage, the SSD is operated whereby the input voltage Vcc is greater than the difference between a select gate drain voltage (VSGD) and a maximum threshold voltage (Vt) of a programmed memory cell. More specifically, during inhibit (FIG. 11B), a voltage VDDSA is applied to a bit line coupled to a memory cell being programmed. In the exemplary embodiment, VDDSA is equal to or close to the power input voltage of the SSD, i.e., VDDSA=Vcc. Since VDDSA is equal to Vcc, the following condition governs during programming: VSGD−Vcc<Vt. During inhibit (FIG. 11A), the select gate drain voltage VSGD must be greater than Vt, i.e., VSGD>Vt. Combining these two conditions produces the following formula which governs operation of the SSD to allow it to operate with the low power input: 0<VSGD−Vt<Vcc. Because Vcc is relatively low, this means that the difference of VSGD and threshold voltage Vt of a programmed memory cell must also be relatively low. This is accomplished by operating the SSD only in the SLC mode.

Turning now to the third parameter, programming of the memory cells utilizes an incremental step pulse programming (ISPP) approach. That, is all of the memory cells begin the programming operation in an erased state, and programming occurs in multiple programming loops, each of which includes a programming pulse and a verify pulse and whereby a magnitude of the programming pulse is increased between programming pulses. However, unlike other known ISPP programming operations, a pre-verify operation is performed before the application of the programming pulse to identify which memory cells that are being programmed to the single programmed data state 51 are at the lowest threshold voltages Vt. As discussed in further detail below, these programming techniques help minimize current peaks during the later verify operation, thereby reducing the power that the SSD requires and allow the SSD to operate at the lower input voltage.

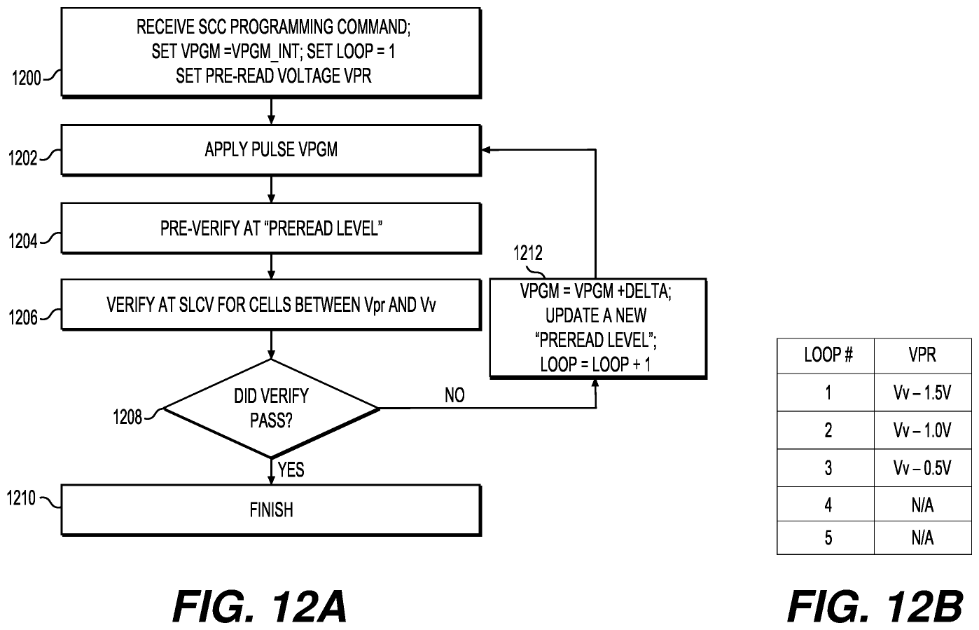

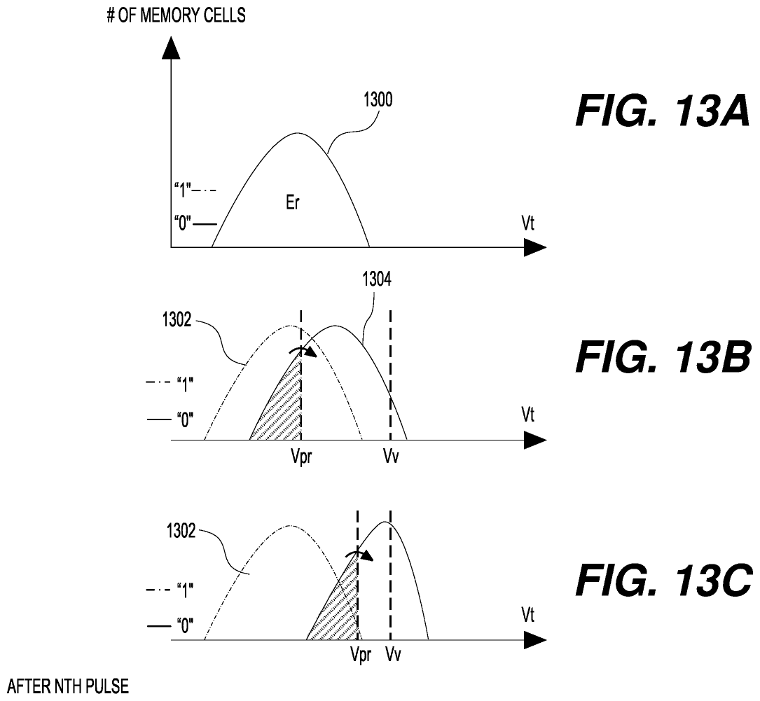

FIG. 12A is a flow chart depicting the method steps according to a programming technique for an SLC memory device that minimizes current during verify and, by extension, power demand. The memory cells begin this operation in an erased state, an example threshold voltage of which is shown with line 1300 in FIG. 13A. At step 1200, a programming command is received by the controller of the SSD from the host; a programming voltage Vpgm is set at an initial programming voltage Vpgm Int (Vpgm=Vpgm Int); a loop counter Loop is set to 1; and a pre-read voltage Vpr is set as a function of the Loop. In an embodiment, the pre-read voltage Vpr may be set according to a pre-established table stored in the SSD, e.g., the Table set forth in FIG. 12B. As shown in the Table of FIG. 12B, in this example embodiment, for the first three programming loops, the pre-read voltage Vpr is set at a level that is less than the verify voltage Vv by decreasing amounts with increasing loops. Specifically, in the first programming loop, the pre-read voltage Vpr is 1.5 V less than the verify voltage Vv; in the second programming loop, the pre-read voltage Vpr is 1.0 V less than the verify voltage Vv; and in the third programming loop, the pre-read voltage Vpr is 0.5 V less than the verify voltage Vv. In other words, the pre-read voltage Vpr is loop-dependent and is less than the verify voltage Vv by fixed amounts, depending on the loop. At this stage in the programming operation, the memory cells to remain in the erase data state Er are inhibited from the following operations.

At step 1202, a programming pulse Vpgm is applied to the control gate of a selected word line being programmed, and an inhibit voltage is applied to the memory cells to remain in the erase state Er to inhibit programming of those memory cells. The uninhibited memory cells are programmed to increase their respective threshold voltages. Following step 1202, as shown in FIG. 13B, the threshold voltages of the memory cells being programmed to data state 51 are increased (see line 1302) while the memory cells remaining in the Er data state remain unchanged (see line 1304).

At step 1204, a pre-verify operation is performed on all of the uninhibited memory cells of the selected word line, i.e., the memory cells that are being programmed to the data state 51. The pre-verify operation includes applying the pre-read voltage Vpr to the control gate of the selected word line. The pre-verify operation identifies which of the memory cells have threshold voltages Vt that are less than the pre-read voltage Vpr, i.e., which memory cells are in a deep erase condition with a very low voltage threshold Vt. For example, the shaded area of FIG. 13B identifies the memory cells that are in the deep erase state.

The current drawn during a verify operation is proportional to the difference between the verify voltage and the threshold voltage of the memory cell being verified. This difference is hereinafter referred to as “overdrive” and is directly related to power demand. That is, a low overdrive means lower current and lower power demand, and a high overdrive means higher current and high power demand. Because the pre-verify operation is performed using the pre-read voltage Vpr, which is less than the verify voltage, the overdrive is substantially less than would be the case if a normal verify operation at a verify voltage Vv were applied to all of the uninhibited memory cells.

At step 1206, a verify operation is performed only on the uninhibited memory cells that have threshold voltages Vt that are greater than the pre-verify voltage Vpr and less than the verify voltage Vv, i.e., the unshaded area under the line 1304 in FIG. 13B. In other words, only the memory cells that passed the pre-verify operation of step 1204 are verified at step 1206. The remaining uninhibited memory cells (i.e., the shaded area under the line 1304 of FIG. 13B), are locked out from this verify operation in this loop. Because the memory cells identified as having threshold voltages Vt that are less than the pre-read voltage Vpr are not verified during this step, the overdrive is minimized, and the power required to conduct the verify operation is less than if no pre-verify operation had been performed.

At decision step 1208, it is determined if the selected word line has passed verify. This entails counting the number of memory cells that did not pass either the pre-verify operation of step 1204 or the verify operation of step 1206 and comparing that count to a pre-determined fail bit count.

If the answer at decision step 1208 is yes, then the programming operation is completed at step 1210.

If the answer at decision step 1210 is no, then at step 1212, the programming voltage Vpgm is incrementally increased (Vpgm=Vpgm+dVpgm); the loop counter Loop is advanced (Loop=Loop+1); and the pre-read voltage Vpr is updated according to the predetermined table, e.g., the Table of FIG. 12B. The method then returns to step 1202. This operation continues until programming fails or is completed.

For illustrative purposes, FIG. 13C illustrates the voltage threshold distributions of the memory cells of a selected word line following the programming pulse at step 1202 of the second loop (Loop=2) with line 1304 identifying the voltage thresholds of the memory cells being programmed to data state 51. By comparing FIGS. 13B and 13C, it can be seen that the pre-read voltage Vpr has been incrementally advanced from the first loop to the second loop to capture more memory cells during the pre-verify operation of the second loop.

In this embodiment as defined by the table of FIG. 12B, during the fourth and fifth and any subsequent programming loops (Loop 4), the pre-read voltage Vpr is equal to the verify voltage Vv, and therefore, the pre-verify operation of step 1204 may be skipped. In some embodiments, the pre-verify operation may be skipped at different programming loops or the pre-verify operation may never be skipped.

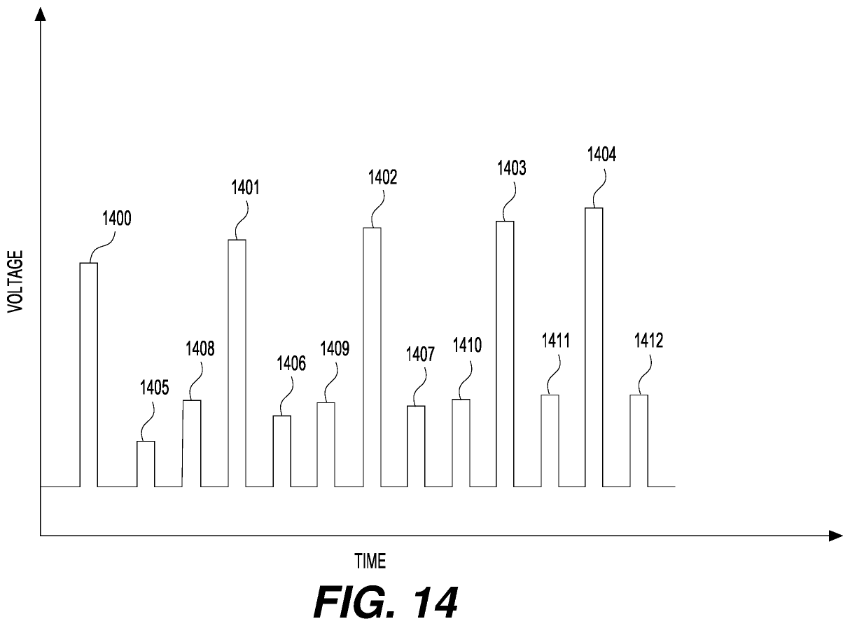

FIG. 14 depicts a waveform of the voltages applied to the control gate of the selected word line during an exemplary programming operation according to the operation depicted in FIG. 12A. Reference numerals 1400-1404 identify the Vpgm pulses at progressively increasing voltages, reference numerals 1405-1407 identify the pre-read voltages Vpr at increasing voltages, and reference numerals 1408-1412 identify the verify voltages Vv. The first programming loop includes voltage pulses 1400, 1405, and 1408; the second programming loop includes voltage pulses 1401, 1406, and 1409; the third programming loop includes voltage pulses 1402, 1407, and 1410; the fourth programming loop includes voltage pulses 1403 and 1411; and the fifth programming loop includes voltage pulses 1404 and 1412.

By operating according to the above-discussed programming technique, the peak power demand during verify is reduced substantially, thereby allowing the SSD to operate at the lower power input voltage as compared to other known SSDs.

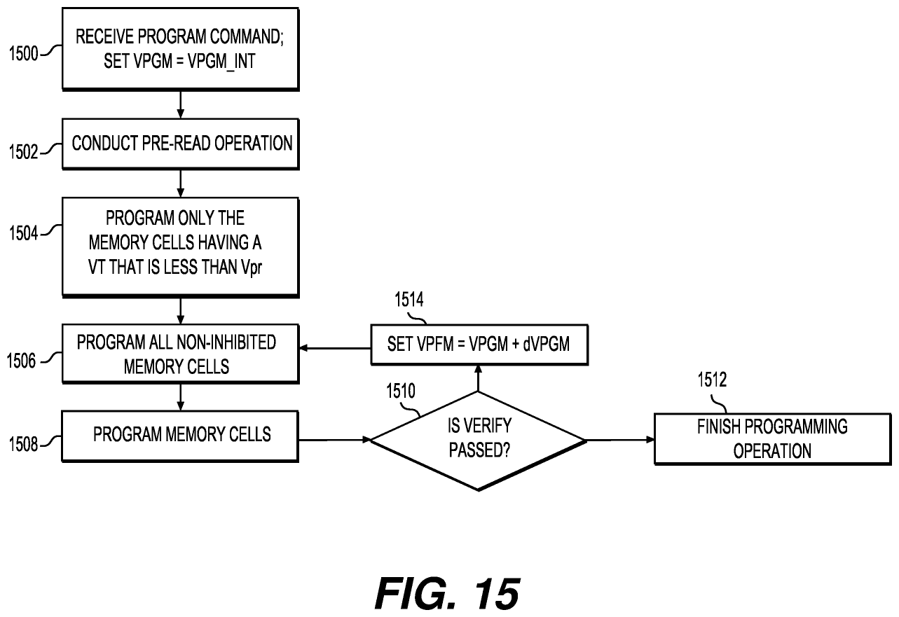

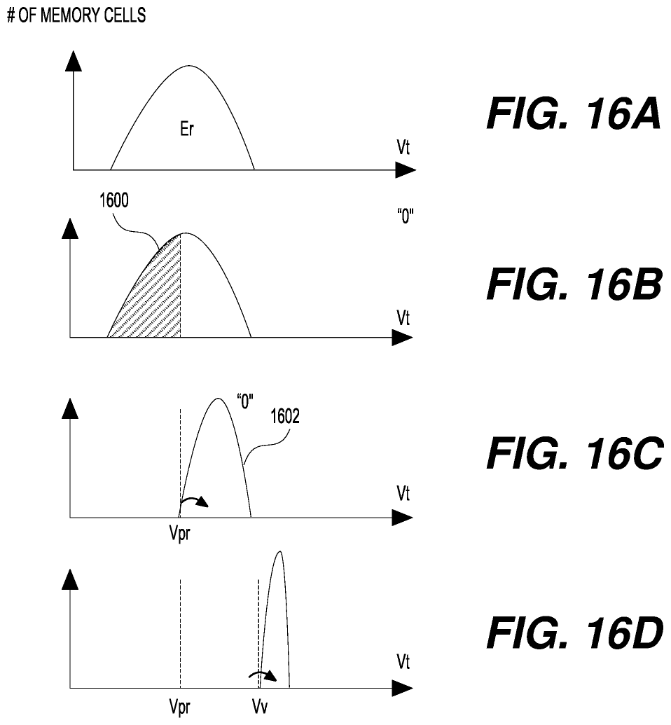

Referring now to FIGS. 15 and 16A-D, another exemplary embodiment of a programming technique is depicted. At step 1500, a programming command is received, and a programming voltage Vpgm is set to an initial programming voltage Vpgm Int. The memory cells of the selected word line that are intended to remain in the erase data state Er are inhibited from the following operations. FIG. 16A illustrates a threshold voltage Vt distribution of the memory cells of the selected word line at the start of the programming operation, i.e., all memory cells are in the erase data state Er.

At step 1502, a pre-verify operation is conducted whereby a pre-read voltage Vpr, which is less than a verify voltage Vv, is applied to the selected word line to identify the memory cells of the selected word line that have a threshold voltage Vt that is less than the pre-read voltage Vpr. The shaded area under the line 1600 of FIG. 16B illustrates the memory cells which are identified in this step. Because the pre-read voltage Vpr is less than the verify voltage Vv, the overdrive and power demand during the pre-verify operation are relatively low.

At step 1504, a pre-programming operation is performed whereby only the memory cells identified at step 1502 as having a threshold voltage Vt that is less than the pre-read voltage Vpr (i.e., the memory cells that fit in the shaded area of FIG. 16B) are programmed using a programming pulse Vpgm, which is applied to the control gate of the selected word line. As a result of programming only these selected memory cells, as opposed to all of the uninhibited memory cells, only the lower tail of the threshold voltage Vt distribution shifts rightward, as illustrated with the line 1602 in FIG. 16C. Thus, the threshold voltage Vt distribution of the memory cells being programmed to data state 51 is compacted during step 1504.

At step 1506, a programming pulse is applied to all of the non-inhibited memory cells.

At step 1508, a verify operation is performed whereby the verify voltage Vv is applied to the control gate of the selected word line to identify which memory cells have a threshold voltage Vt that is greater than the verify voltage Vv and which have a threshold voltage Vt that is less than the verify voltage Vv. Because the Vt distribution of the uninhibited memory cells was compacted during the pre-verify and pre-programming operations of steps 1502 and 1504, the overdrive and power demand during the verify operation of step 1508 are both reduced as compared to if no pre-verify operation was completed.

At decision step 1510, it is determined if the verify operation of step 1508 has passed, i.e., if the number of memory cells having threshold voltages Vt below the verify voltage Vv is less than a pre-determined fail bit count. If the answer at decision step 1510 is yes, then programming is completed at step 1512.

If the answer at decision step 1510 is no, then at step 1514, the programming voltage is incrementally advanced (Vpgm=Vpgm+dVpgm). The method then returns to step 1506.

By pre-programming only the memory cells having low threshold voltages at step 1504, the overdrive at the verify operation of step 1508 is minimized. This reduces the power demand during the verify operation, thereby allowing the SSD to operate reliably despite the aforementioned reduced power input.

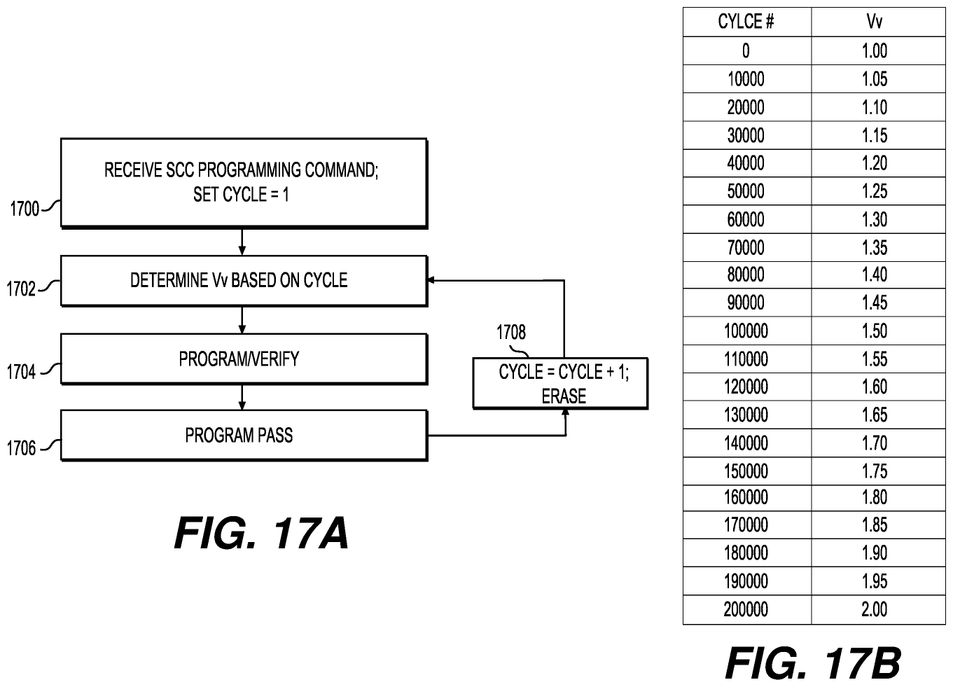

According to another aspect of the present disclosure, to promote endurance the SSD is configured to alter its operation over time as the dielectric degrades by adjusting the verify voltage Vv applied during the verify operation to increase the threshold voltages of the memory cells programmed to the data state Si. Referring to FIG. 17A, at step 1700, a programming command is received, and a program-erase cycle counter Cycle is set at 1.

At step 1702, the verify voltage Vv to be applied during a following verify operation is determined as a function of Cycle. With reference to FIG. 17B, in the exemplary embodiment, a Table is provided which correlates the verify voltage Vv to Cycle. For example, for Cycles 0-10,000, Vv is set to 1.00 V; for Cycles 10,000-20,000, Vv is set to 1.05 V; for Cycles 20,000-30,000, Cycle is set to 1.10 V; etc.

The progressively increasing verify voltage Vv over the life of the SSD increases the endurance of the memory device. Specifically, when the SSD is new, very little charge loss occurs, and therefore, damage to the dielectric layer and power demand are both minimized by keeping the verify level low. However, as the number of program-erase cycles increases, the increase in the verify level allows the SSD to tolerate more charge loss due to electrons leaking through the worn dielectric layer. This method may be employed along with the methods described above and depicted in the flow chart of FIG. 12A. In doing so, because the pre-read voltages Vpr applied during the aforementioned pre-verify operations are correlated to the verify voltage Vv, as the verify voltage Vv increases over the life of the SSD, so will the pre-read voltages Vpr.

At step 1704, the memory cells are programmed and then verified until programming is completed at step 1706.

At step 1708, an erase command is received, the memory cells are erased, and the cycle count is incrementally advanced (Cycle=Cycle+1). The method returns to step 1702.

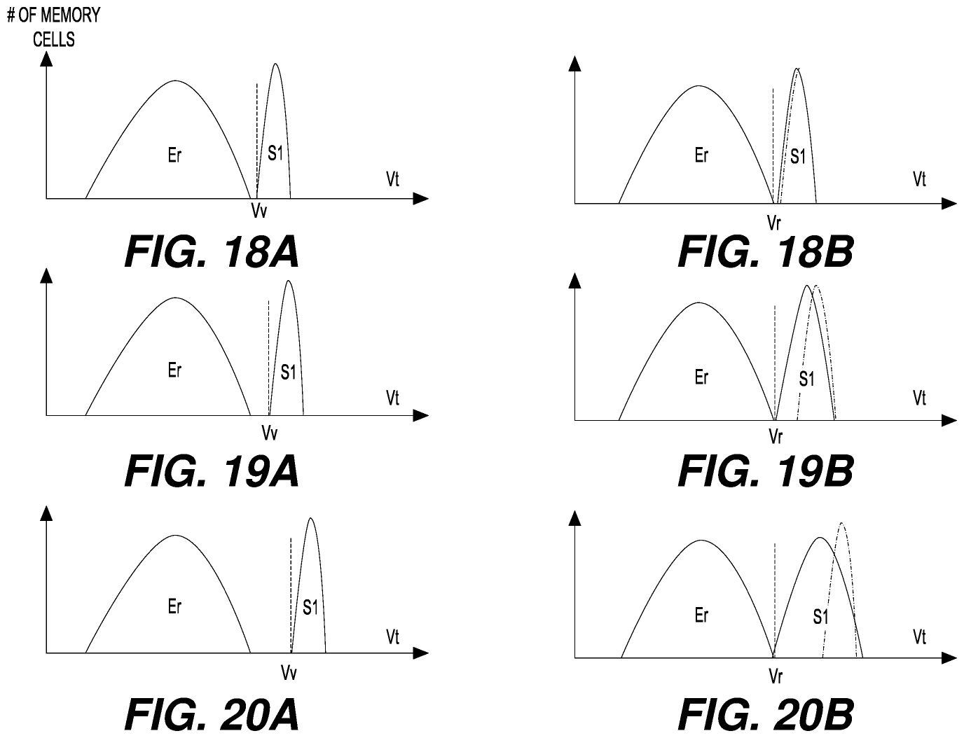

FIGS. 18A, 19A, and 20A illustrate the threshold voltage distributions of the memory cells immediately after programming in a new SSD with very few program-erase cycles, after a first number of program-erase cycles (for example, 50,000 program-erase cycles), and after a greater second number of program-erase cycles (for example, 200,000 program-erase cycles). As shown, the verify voltage Vv has been increased from FIG. 18A to FIG. 19A and then increased further in FIG. 20A.

Turning now to FIGS. 18B, 19B, and 20B, the threshold voltage distributions are shown after a predetermined time following programming, e.g., six months. Of these three Figures, the lower tale of the Vt distribution has shifted downward the least in the new SSD depicted in FIG. 18B and has shifted downwardly the most in the SSD with the most program-erase cycles as depicted in FIG. 20B due to charge loss. However, in FIGS. 19B and 20B, the lower tails of the threshold voltage distributions for the memory cells of the 51 data state remain above a read Voltage Vr. Therefore, the data of the SSD, even after some degradation in the dielectric layer, can still be easily read because the memory cells of the 51 data state were programmed to such a high threshold voltage during programming. In other words, the use of the higher verify voltage Vv during programming after the SSD has undergone a high number of program-erase cycles improves data retention and endurance.

The several aspects of the present disclosure may be embodied in the form of an apparatus, system, method, or computer program process. Therefore, aspects of the present disclosure may be entirely in the form of a hardware embodiment or a software embodiment (including but not limited to firmware, resident software, micro-code, or the like), or may be a combination of both hardware and software components that may generally be referred to collectively as a “circuit,” “module,” “apparatus,” or “system.” Further, various aspects of the present disclosure may be in the form of a computer program process that is embodied, for example, in one or more non-transitory computer-readable storage media storing computer-readable and/or executable program code.

Additionally, various terms are used herein to refer to particular system components. Different companies may refer to a same or similar component by different names and this description does not intend to distinguish between components that differ in name but not in function. To the extent that various functional units described in the following disclosure are referred to as “modules,” such a characterization is intended to not unduly restrict the range of potential implementation mechanisms. For example, a “module” could be implemented as a hardware circuit that includes customized very-large-scale integration (VLSI) circuits or gate arrays, or off-the-shelf semiconductors that include logic chips, transistors, or other discrete components. In a further example, a module may also be implemented in a programmable hardware device such as a field programmable gate array (FPGA), programmable array logic, a programmable logic device, or the like. Furthermore, a module may also, at least in part, be implemented by software executed by various types of processors. For example, a module may comprise a segment of executable code constituting one or more physical or logical blocks of computer instructions that translate into an object, process, or function. Also, it is not required that the executable portions of such a module be physically located together, but rather, may comprise disparate instructions that are stored in different locations and which, when executed together, comprise the identified module and achieve the stated purpose of that module. The executable code may comprise just a single instruction or a set of multiple instructions, as well as be distributed over different code segments, or among different programs, or across several memory devices, etc. In a software, or partial software, module implementation, the software portions may be stored on one or more computer-readable and/or executable storage media that include, but are not limited to, an electronic, magnetic, optical, electromagnetic, infrared, or semiconductor-based system, apparatus, or device, or any suitable combination thereof. In general, for purposes of the present disclosure, a computer-readable and/or executable storage medium may be comprised of any tangible and/or non-transitory medium that is capable of containing and/or storing a program for use by or in connection with an instruction execution system, apparatus, processor, or device.

Similarly, for the purposes of the present disclosure, the term “component” may be comprised of any tangible, physical, and non-transitory device. For example, a component may be in the form of a hardware logic circuit that is comprised of customized VLSI circuits, gate arrays, or other integrated circuits, or is comprised of off-the-shelf semiconductors that include logic chips, transistors, or other discrete components, or any other suitable mechanical and/or electronic devices. In addition, a component could also be implemented in programmable hardware devices such as field programmable gate arrays (FPGA), programmable array logic, programmable logic devices, etc. Furthermore, a component may be comprised of one or more silicon-based integrated circuit devices, such as chips, die, die planes, and packages, or other discrete electrical devices, in an electrical communication configuration with one or more other components via electrical conductors of, for example, a printed circuit board (PCB) or the like. Accordingly, a module, as defined above, may in certain embodiments, be embodied by or implemented as a component and, in some instances, the terms module and component may be used interchangeably.

Where the term “circuit” is used herein, it includes one or more electrical and/or electronic components that constitute one or more conductive pathways that allow for electrical current to flow. A circuit may be in the form of a closed-loop configuration or an open-loop configuration. In a closed-loop configuration, the circuit components may provide a return pathway for the electrical current. By contrast, in an open-looped configuration, the circuit components therein may still be regarded as forming a circuit despite not including a return pathway for the electrical current. For example, an integrated circuit is referred to as a circuit irrespective of whether the integrated circuit is coupled to ground (as a return pathway for the electrical current) or not. In certain exemplary embodiments, a circuit may comprise a set of integrated circuits, a sole integrated circuit, or a portion of an integrated circuit. For example, a circuit may include customized VLSI circuits, gate arrays, logic circuits, and/or other forms of integrated circuits, as well as may include off-the-shelf semiconductors such as logic chips, transistors, or other discrete devices. In a further example, a circuit may comprise one or more silicon-based integrated circuit devices, such as chips, die, die planes, and packages, or other discrete electrical devices, in an electrical communication configuration with one or more other components via electrical conductors of, for example, a printed circuit board (PCB). A circuit could also be implemented as a synthesized circuit with respect to a programmable hardware device such as a field programmable gate array (FPGA), programmable array logic, and/or programmable logic devices, etc. In other exemplary embodiments, a circuit may comprise a network of non-integrated electrical and/or electronic components (with or without integrated circuit devices). Accordingly, a module, as defined above, may in certain embodiments, be embodied by or implemented as a circuit.

It will be appreciated that example embodiments that are disclosed herein may be comprised of one or more microprocessors and particular stored computer program instructions that control the one or more microprocessors to implement, in conjunction with certain non-processor circuits and other elements, some, most, or all of the functions disclosed herein. Alternatively, some or all functions could be implemented by a state machine that has no stored program instructions, or in one or more application-specific integrated circuits (ASICs) or field-programmable gate arrays (FPGAs), in which each function or some combinations of certain of the functions are implemented as custom logic. A combination of these approaches may also be used. Further, references below to a “controller” shall be defined as comprising individual circuit components, an application-specific integrated circuit (ASIC), a microcontroller with controlling software, a digital signal processor (DSP), a field programmable gate array (FPGA), and/or a processor with controlling software, or combinations thereof.

Further, the terms “program,” “software,” “software application,” and the like as may be used herein, refer to a sequence of instructions that is designed for execution on a computer-implemented system. Accordingly, a “program,” “software,” “application,” “computer program,” or “software application” may include a subroutine, a function, a procedure, an object method, an object implementation, an executable application, an applet, a servlet, a source code, an object code, a shared library/dynamic load library and/or other sequence of specific instructions that is designed for execution on a computer system.

Additionally, the terms “couple,” “coupled,” or “couples,” where may be used herein, are intended to mean either a direct or an indirect connection. Thus, if a first device couples, or is coupled to, a second device, that connection may be by way of a direct connection or through an indirect connection via other devices (or components) and connections.

Regarding, the use herein of terms such as “an embodiment,” “one embodiment,” an “exemplary embodiment,” a “particular embodiment,” or other similar terminology, these terms are intended to indicate that a specific feature, structure, function, operation, or characteristic described in connection with the embodiment is found in at least one embodiment of the present disclosure. Therefore, the appearances of phrases such as “in one embodiment,” “in an embodiment,” “in an exemplary embodiment,” etc., may, but do not necessarily, all refer to the same embodiment, but rather, mean “one or more but not all embodiments” unless expressly specified otherwise. Further, the terms “comprising,” “having,” “including,” and variations thereof, are used in an open-ended manner and, therefore, should be interpreted to mean “including, but not limited to . . . ” unless expressly specified otherwise. Also, an element that is preceded by “comprises . . . a” does not, without more constraints, preclude the existence of additional identical elements in the subject process, method, system, article, or apparatus that includes the element.

The terms “a,” “an,” and “the” also refer to “one or more” unless expressly specified otherwise. In addition, the phrase “at least one of A and B” as may be used herein and/or in the following claims, whereby A and B are variables indicating a particular object or attribute, indicates a choice of A or B, or both A and B, similar to the phrase “and/or.” Where more than two variables are present in such a phrase, this phrase is hereby defined as including only one of the variables, any one of the variables, any combination (or sub-combination) of any of the variables, and all of the variables.

Further, where used herein, the term “about” or “approximately” applies to all numeric values, whether or not explicitly indicated. These terms generally refer to a range of numeric values that one of skill in the art would consider equivalent to the recited values (e.g., having the same function or result). In certain instances, these terms may include numeric values that are rounded to the nearest significant figure.

In addition, any enumerated listing of items that is set forth herein does not imply that any or all of the items listed are mutually exclusive and/or mutually inclusive of one another, unless expressly specified otherwise. Further, the term “set,” as used herein, shall be interpreted to mean “one or more,” and in the case of “sets,” shall be interpreted to mean multiples of (or a plurality of) “one or more,” “ones or more,” and/or “ones or mores” according to set theory, unless expressly specified otherwise.

The foregoing detailed description has been presented for purposes of illustration and description. It is not intended to be exhaustive or be limited to the precise form disclosed. Many modifications and variations are possible in light of the above description. The described embodiments were chosen to best explain the principles of the technology and its practical application to thereby enable others skilled in the art to best utilize the technology in various embodiments and with various modifications as are suited to the particular use contemplated. The scope of the technology is defined by the claims appended hereto.

What is claimed is:

1. A method of operating a memory device, comprising the steps of:
preparing a memory device that includes a plurality of memory cells arranged in a plurality of word lines;
programming the memory cells of a selected word line of the plurality of word lines in a plurality of programming loops to store a single bit of data in each memory cell of the selected word line, the programming loops comprising programming operations that include applying a programming voltage to the selected word line and verify operations that include applying a verify voltage to the selected word line; and
at least one of the programming loops of the plurality of programming loops further including a pre-verify operation, the pre-verify operation including applying a pre-read voltage to the selected word line, and wherein the pre-read voltage is less than the verify voltage.

2. The method as set forth in claim 1 wherein only a first programming loop of the plurality of programming loops includes the pre-verify operation.

3. The method as set forth in claim 2 wherein in the first programming loop of the plurality of programming loops, the pre-verify operation identifies a set of low threshold voltage memory cells that have threshold voltages that are less than the pre-read voltage, and wherein only the set of low threshold voltage memory cells are programmed during the programming operation of the first programming loop.

4. The method as set forth in claim 1 wherein at least a first programming loop and a second programming loop of the plurality of programming loops include pre-verify operations.

5. The method as set forth in claim 4 wherein the pre-read voltage applied to the selected word line during the pre-verify operation of the first programming loop is a first pre-read voltage, wherein the pre-read voltage applied to the selected word line during the pre-verify operation of the second programming loop is a second pre-read voltage, and wherein the second pre-read voltage is greater than the first pre-read voltage.

6. The method as set forth in claim 4 wherein during at least the first programming loop and the second programming loop, the pre-verify operation identifies a set of low threshold voltage memory cells that have threshold voltages that are less than the pre-read voltage and during the verify operation of at least the first programming loop, the set of low threshold voltage memory cells are locked out.

7. The method as set forth in claim 6 wherein the pre-read voltage is determined as a function of the verify voltage.

8. The method as set forth in claim 1 further including the steps of tracking lifetime program-erase cycles in the memory device and increasing the verify voltage with increasing program-erase cycles.

9. The method as set forth in claim 1 wherein the memory device only has a single power input that is no greater than 1.5 V.

10. A storage device, comprising:
a non-volatile memory including a control circuitry that is communicatively coupled to a memory block that includes a plurality of memory cells arranged in a plurality of word lines, wherein the control circuitry is further configured to:
program the memory cells of a selected word line of the plurality of word lines in a plurality of programming loops to store a single bit of data in each memory cell of the selected word line, the programming loops comprising programming operations that include applying a programming voltage to the selected word line and verify operations that include applying a verify voltage to the selected word line; and
at least one of the programming loops of the plurality of programming loops further including a pre-verify operation, the pre-verify operation including applying a pre-read voltage to the selected word line, and wherein the pre-read voltage is less than the verify voltage.

11. The storage device as set forth in claim 10 wherein the control circuitry is configured to only include the pre-verify operation in a first programming loop of the plurality of programming loops.

12. The storage device as set forth in claim 11 wherein the control circuitry is configured such that, in the first programming loop of the plurality of programming loops, a set of low threshold voltage memory cells that have threshold voltages that are less than the pre-read voltage are identified in the pre-verify operation, and only the set of low threshold voltage memory cells are programmed during the programming operation.

13. The storage device as set forth in claim 10 wherein the control circuitry is configured such that at least a first programming loop and a second programming loop of the plurality of programming loops include pre-verify operations.

14. The storage device as set forth in claim 13 wherein the control circuitry is configured such that the pre-read voltage that is applied to the selected word line during the first programming loop is a first pre-read voltage, the pre-read voltage that is applied to the selected word line during the second programming loop is a second pre-read voltage, and the second pre-read voltage is greater than the first pre-read voltage.

15. The storage device as set forth in claim 13 wherein the control circuitry is configured such that, during the pre-verify operations of at least the first programming loop and the second programming loop, a set of low threshold voltage memory cells that have threshold voltages that are less than the pre-read voltage are identified, and the control circuitry locks out the set of low threshold voltage memory cells during the verify operations of at least the first programming loop and the second programming loop.

16. The storage device as set forth in claim 15 wherein the control circuitry determines the pre-read voltage as a function of the verify voltage.

17. The storage device as set forth in claim 10 wherein the control circuitry is configured to track lifetime program-erase cycles of the storage device and automatically increase the verify voltage with increasing program-erase cycles.

18. The storage device as set forth in claim 10 wherein the non-volatile memory only includes a single power input that is no greater than 1.5 V.

19. An apparatus, comprising:
a non-volatile memory device including a programming means for programming a single bit of data into each memory cell of a plurality of memory cells arranged in a plurality of word lines, the programming means being further configured to:
program the memory cells of a selected word line of the plurality of word lines in a plurality of programming loops, the programming loops comprising programming operations that include applying a programming voltage to the selected word line and verify operations that include applying a verify voltage to the selected word line;
at least one of the programming loops of the plurality of programming loops further including a pre-verify operation, the pre-verify operation including applying a pre-read voltage to the selected word line, and wherein the pre-read voltage is less than the verify voltage; and
wherein in the at least one of the programming loops that includes the pre-verify operation, the programming operation or the verify operation is adjusted based on results of the pre-verify operation.

20. The apparatus as set forth in claim 19 wherein the non-volatile memory device only includes a single power input that is no greater than 1.5 V.
